(19) United States
(12) Patent Application Publication
(10) Pub. No.: US 2023/0358675 A1
(43) Pub. Date: Nov. 9, 2023

(54) FLUID QUALITY MONITORING SYSTEM AND METHOD

(71) Applicant: AQUALITAS TECHNOLOGIES LTD, Karmiel (IL)

(72) Inventors: Georgy MAIKOV, Haifa (IL); Jenya TILCHIN, Haifa (IL)

(21) Appl. No.: 18/042,419

(22) PCT Filed: Aug. 23, 2021
(86) PCT No.: PCT/IL2021/051030

§ 371 Date: Feb. 21, 2023

Related U.S. Application Data
(60) Provisional application No. 63/069,719, filed on Aug. 25, 2020.

(51) Int. Cl. G01N 21/53; G01N 21/85; G01N 35/00

(52) U.S. Cl. CPC G01N 21/532; G01N 21/85; G01N 35/00871; G01N 2201/12738; G01N 2201/062

(57) ABSTRACT

A monitoring system is presented for monitoring quality of fluid in a fluid chamber. The system includes: a sensing system which comprises sensing units of different types configured to measure multiple parameters of the fluid and generate corresponding measured fluid quality data and to perform self-diagnostic of an operational condition of the sensing system and generate sensing data indicative of sensing quality, and a control system comprising a local controller configured to be responsive to data indicative of a relation between the measured fluid quality data and the sensing quality and selectively generate operational data to initiate one or more of the following: generation of alarm signal indicative of an abnormal condition of the quality of the fluid, correction of the measured fluid quality data in accordance with the sensing quality; and replacement of one or more elements of the sensing units.

### TECHNOLOGICAL FIELD

The present invention is generally in the field of sensing and measurement techniques and relates to a monitoring system and method for monitoring fluid quality.

### BACKGROUND

Commercially available fluid monitoring sensors include sensors that are capable of measuring representative parameters for an entire family of contaminants, sensors that can be specific for general fluid, and sensors that can be analyte-specific. Generally, such sensors can be divided into three groups by their operation principle: electrochemical, direct/pure optical, and colorimetric. Some of the analytes can be measured with more than one sensing operation principle.

In order to determine quantitative value by direct optical sensors, complex calibration procedures and algorithmic approaches are required, i.e. matrix calibration process accompanied by chemometric analysis and model. In contrast to a direct optical sensor, colorimetric sensors require addition of optically active and specific to target analyte chemicals in order to create a unique spectrometric signature for quantitative analysis. Colorimetric sensors provide the deepest analyte wise data on fluid composition.

The electrochemical sensors are the most commonly used sensors since they are comparably cheap and can be simply replaced when required. The measurement principle of electrochemical sensors is to detect an electrical property of fluid using a special electrode that is specific to a family of analytes (i.e. Electrical Conductivity, ORP) or even analyte-specific (i.e. ion-specific electrodes—ISE).

Generally speaking, electrochemical sensors are sensitive to changes in fluid parameters like pH, temperature, and interfering chemicals, and to the inherent physical properties of electrochemical methods like potential drift with time. The electrochemical sensors provide the most general data on fluid composition and degree of contamination.

Various techniques have been developed using optical spectral measurements for evaluating the liquid quality.

For example, US 2018/164210 describes a device for measuring an absorption spectrum of a liquid, such as water with organic contaminants, utilizing an array of LEDs each emitting light with a unique spectral peak.

US 2007/092407 describes total analysis systems and methods for simultaneously monitoring a suite of biological and/or chemical species in water. The system provides a sample-volume controlled sensor array comprising a fluid delivery device and a plurality of optical sensor elements for determining the presence and total concentrations of multiple analytes in the process system simultaneously. Image identification algorithms are provided for identifying the analytes based on image intensity, color pattern, positional arrangement, and the like. The methods incorporate multivariate optimization algorithms to analyze multiple sensor responses.

Sensing/measurement systems require proper calibration and maintenance. Various techniques have been developed for this purpose. Some examples of such techniques are described in US 2019/271615 and US 2019/297397.

### SUMMARY

There is a need in the art for a novel approach for monitoring fluid quality by a sensing system, while concurrently monitoring the operational condition of the sensing system itself to improve the sensor stability and reduce the maintenance requirements.

The present invention provides a novel fluid quality monitoring system, composed of plurality of sensing units configured to monitor various physicochemical parameter that denote the fluid quality condition, as well as maintenance condition of the sensing units in the sensing system itself (i.e. sensing quality). The sensing system is preferably configured as a combined modular system enabling simple replacement of the elements of the sensing system.

The sensing system includes electrical/electrochemical sensing unit(s) which may be of any known suitable type configured to perform (continuously or periodically or according to a predetermined time pattern) sensing sessions to obtain sensing data indicative of material-relating parameters of the fluid contents. Also, the sensing system includes optical sensing unit(s). The latter is/are configured to perform optical sensing sessions to obtain sensing data indicative of material-relating parameters of the fluid contents (which may or may not be related to materials different from those sensed by the electrical/electrochemical sensing unit(s)), and also to determine the operational condition of the optical sensing unit(s) by monitoring optical properties of the optical sensing unit(s).

Thus, the present invention provides a monitoring system including a combined sensing system in which measurements of the electrical/electrochemical sensing unit(s) is/are combined with measurements of the optical sensing unit(s) for sensing the fluid quality, and where the optical sensing unit(s) is/are capable of performing self-diagnostic of the quality of the sensing system. The monitoring system also includes a control system which may be configured to perform analysis of fluid quality measured data and sensing quality data, or may communicate with a remote central system where such analysis is performed, or functional utilities/modules of the data processor and analyzer are distributed between the control system of the monitoring system and the remote central system. The control system of the monitoring system includes a local controller which is configured to initiate, based on the analysis of the fluid quality and sensing quality data, alarm signal indicative of an abnormal condition of the quality of the fluid and/or correction of the measured fluid quality data in accordance with the sensing quality and/or replacement of one or more elements of the sensing units.

In some embodiments, correlation between a change in the quality status of the optical sensing and electrical/electrochemical sensing system is determined and further used to decide about the status (operational condition) of the electrical/electrochemical sensing unit(s) via measurement of the condition of the optical sensing unit(s).

Thus, according to one broad aspect of the invention, there is provided a monitoring system configured for monitoring quality of fluid in a fluid chamber, the monitoring system comprising:
a sensing system which comprises sensing units of different types configured to measure multiple parameters of the fluid and generate corresponding measured fluid quality data and to perform self-diagnostic of an operational condition of the sensing system and generate sensing data indicative of sensing quality, and
a control system comprising a local controller configured to be responsive to data indicative of a relation between the measured fluid quality data and the sensing quality and selectively generate operational data to initiate one or more of the following: generation of alarm signal indicative of an abnormal condition of the quality of the fluid, correction of the measured fluid quality data in accordance with the sensing quality; and replacement of one or more elements of the sensing units.

The fluid chamber may or may not be configured for fluid flow therethrough.

The sensing units comprise at least one electrochemical sensing unit configured to measure one or more substances in the fluid and generate first measured data indicative thereof, and at least one optical sensing unit configured to measure one or more substances in the fluid and generate second measured data, the first and second measured data forming said measured fluid quality data. The optical sensing unit(s) include(s) at least one optical sensing unit configured to measure one or more parameters characterizing quality of optical measurements performed by said at least one optical sensing unit and generate optical sensing data characterizing the sensing quality.

In some embodiments, the control system includes: a data processor configured to receive and analyze the measured fluid quality data and derive therefrom qualitative and quantitative data indicative of a quality level of the fluid being measured; and an analyzer configured to receive and analyze the sensing quality data and upon identifying deviation of the operational condition of the sensing system from a predetermined normal condition, determining, based on a degree of said deviation, whether the data indicative of the quality level of the fluid derived from the measured fluid quality data is affected by said deviation, and generate said data indicative of the relation between the measured fluid quality data and the sensing quality defining said operational data.

The control system may be configured and operable as a node of a fluid network formed by a plurality of similar monitoring systems connectable via a communication network. The analyzer is thus preferably configured to apply machine learning to measured and sensing data obtained by one or more of the similar monitoring systems and evaluate an effect of the sensing quality on the quality level of the measured fluid, and determine the data indicative of the relation between the measured fluid quality data and the sensing quality.

In some embodiments, the monitoring system further includes a communication utility configured to communicate the measured fluid quality data and the sensing data to a remote central system and receive therefrom and communicate to the local controller said data indicative of the relation between the measured fluid quality data and the sensing quality.

In some embodiments, the control system comprises a data processor configured to receive and analyze the measured fluid quality data and derive therefrom qualitative and quantitative data indicative of a quality level of the fluid being measured, and communicate said data to the local controller; and the monitoring system includes a communication utility configured to communicate the data indicative of the quality of the fluid and the sensing data to a remote central system, and receive therefrom and communicate to the local controller said data indicative of the relation between the measured fluid quality data and the sensing quality defining said operational data.

The monitoring system may be associated with an identification code assigned thereto, and the communication utility is configured to communicate to the remote central system at least one of the measured and sensing data accompanied with said identification code.

The measured fluid quality data may comprise multiple data pieces corresponding to parameters of various substances in the fluid, and a relation between the multiple data pieces defines a quality level of the fluid for a given status of the measured fluid quality data. The operational condition of the sensing system affects such relation between the multiple data pieces.

The control system may be configured to automatically identify the types of the sensing units of the sensing system.

The control system may be configured to utilizes data indicative of the types of the sensing units of the sensing system, and determine, based on the optical sensing data and the relation between the optical sensing data and the measured quality data, correlation between a change in the sensing quality of the at least one optical sensing unit and an operational condition of the at least one electrochemical sensing unit, to update the operational data.

In some embodiments, the monitoring system includes a housing having a modular configuration for carrying multiple individual elements of the sensing system in such modules, thereby enabling replacement of one or more of these elements.

The individual modules may include modules which are configured to carry, respectively, each of the at least one electrochemical sensing unit allowing an active part of the sensing unit to be exposed to the fluid being monitored, and each of light source and detection devices of the at least one optical sensing unit allowing them to be exposed to the fluid being monitored via optical windows.

Generally, at least one of the optical sensing units is associated with optical windows and is configured to illuminate the fluid and detect light returned from the fluid via the optical windows. The detected light is thereby indicative of light response of the one or more substances in the fluid and indicative of optical properties of the optical windows characterizing the quality of the optical measurements performed by said optical sensing unit. The detected light may be indicative of at least one of transmission and scattering properties of each of the optical windows.

The at least one optical sensing unit may be configured to provide the detected light indicative of the light response of the fluid comprising one or more of the following properties of the fluid: absorption; transmission in at least one of ultraviolet, visible, near- and mid-infrared spectra, fluorescence, RAMAN.

The optical sensing unit may comprise: a light source device comprising one or more light sources configured to generate one or more illuminating wavelength ranges to illuminate the fluid and cause the light response of the fluid; and an optical detector device comprising one or more detectors configured to detect light of one or more wavelengths and generate the corresponding measured data indicative of the one or more substances in the fluid.

The optical detector device may comprise at least one detector accommodated to detect light components transmitted through the optical windows and light components scattered from at least one of the optical windows.

The optical windows may be defined at least by transparent portion(s) of the fluid chamber to which the at least one optical sensing unit is exposed, and possibly also by optical windows made in the housing.

In some embodiments, the at least one optical sensing unit is configured to generate illumination of one or more wavelength ranges including one or more of the following: 230 nm, 234 nm, 255 nm, 275 nm, 420 nm, 530 nm, 632 nm, 760 nm, white light.

In some embodiments, the at least one optical sensing unit includes one or more light emitting diodes (LEDs).

The sensing units may be configured to determine two or more of the following parameters of the fluid: nitrate contents, turbidity, color, iron contents, total organic carbon contents, assimilable organic carbon contents, total dissolves solids contents, hardness, alkalinity, bacteria.

In some embodiments, the housing is configured to define at least one substantially U-shaped structure defining an inner space for receiving at least a part of the fluid chamber having at least one optically transparent portion. Such U-shaped structure carries at least one optical sensing unit, i.e. the light source and the detection devices of the optical sensing unit. For example, the light source of the optical sensing unit is located on one of the arms of the U-shaped structure, at least one of the detection devices is located on the other opposite arm of the U-shaped structure, and at least one other detection device is located in a vicinity of an apex region of the U-shaped structure. This allows the light source and the detection devices to be exposed to the fluid in the chamber and to perform optical measurements of the parameters of the fluid and the self-diagnostic of the operational condition of the sensing system.

Such U-shaped structure may include optical windows, such that when at least a part of the housing including this U-shaped structure is located inside the fluid chamber, the light source and the detection devices of the optical sensing unit are exposed to the fluid via these optical windows.

In some embodiments, the housing is configured to enable monitoring of the fluid passing through/accommodated in a portion of the housing. More specifically, the housing comprises: a body having an inlet and an outlet defining a fluid path therebetween for establishing fluid communication with a fluid line; at least one examination tube configured to be disposed within the body along the fluid path and having at least one at least partially transparent portion for allowing optical measurement of the fluid passing within the examination tube by the at least one optical sensing unit; and at least one examination chamber disposed within the body along the fluid path and carrying the at least one electrochemical sensing unit allowing electrical measurement of the fluid passing within the examination chamber.

The at least partially transparent portion of the fluid chamber (examination tube) can be made from any transparent material, including but not limited to, quartz, glass, rubber, plastic, etc. This material can be chosen so as not to absorb a required portion of the light spectrum.

The examination tube is preferably configured to be located within the body of the housing in a manner allowing its extraction and replacement if required. The extraction and the replacement of the examination tube can be done for maintenance purposes, for example, upon an accumulation of fluid residue therein.

The portion of the housing accommodating the examination tube can further comprise two electrical fluid valves in such a way that the valves can stop the flow of fluid through the fluid path.

The system can include at least one PCB electronic module. This module can include a logic/decision module (data processor and analyzer and/or local controller), a CPU module, a wireless communication module, ADC module, DAC module, etc.

The electronic PCB module(s) can be replaceable and modular.

The housing can include at least one examination chamber disposed along the fluid path. The examination chamber can be separate and distinct from the examination tube, and includes the at least one electrode sensing unit (electro-chemical sensing unit) for allowing electrical or electrochemical measurement of the fluid passing/accommodated within the examination chamber. The examination chamber can be formed with one or more electrode bores configured for receiving the one or more electrode sensing units.

The electrode sensing unit(s) is/are configured to sense a plurality of fluid parameters including, but not limited to, temperature, pH, dissolved oxygen, ammonia, nitrate, oxidation-reduction potential, free chlorine, sodium, chlorine, hardness, electrical conductivity, etc. It is known that such electrode sensing units suffer from drifts during their lifetime, therefore the system and the electrode sensing units are preferably configured to allowing replacement of each of the electrode sensing units. This allows for easy maintenance of the fluid sensing system.

In some embodiment, the electrode sensing units are controlled by the PCB module to derive a series of fluid quality values from the electrode sensing units. The values can be correlated to adjust the performance of said electrode sensing units.

The housing may be configured to define an examination tube receiving chamber configured to facilitate detachable/attachment accommodation of the examination tube therein.

In some embodiments, the examination tube receiving chamber is configured to assemble an additional tube as part of the fluid path. The additional tube can divert the fluid flow from the examination tube in such a way that the examination tube can be replaced.

In some embodiments, the at least partially transparent portion of the examination tube can be used for reference measurement of the fluid that flows through the examination tube.

The examination tube receiving chamber can be configured so as to accommodate at least one U-shaped structure carrying the optical sensing unit and the respective examination tube.

The examination tube receiving chamber can have one or more electric connectors configured for receiving one or more U-shaped structures of the optical sensing units. The U-shaped structure carrying the optical sensing unit may be configured to be inserted into the electrical connectors inside the examination tube receiving chamber in such a way that the U-shaped structure is detachably attachable to the body of the housing.

In some embodiments, the PCB module identifies automatically the kind of the optical sensing unit(s) installed in the examination tube receiving chamber so that the PCB module knows which parameter of the fluid quality the optical sensing unit is measuring and the interdependent correlations with it.

The control system (at least local controller) may be configured to control the state of the valves to properly open and close the valves when necessary.

According to another broad aspect of the invention, there is provided a control system for use in monitoring quality of a fluid. The control system is connected to a communication network configured for data communication with at least one monitoring system including the above described sensing system (comprising sensing units of different types configured to measure multiple parameters of the fluid and generate corresponding measured fluid quality data and to perform self-diagnostic of an operational condition of the sensing system and generate sensing data indicative of sensing quality). The control system is configured as a computer system and comprises a data processor and analyzer configured to be responsive to input data from the monitoring system comprising measured fluid quality data and sensing data, to carry out the following: analyze the measured fluid quality data and derive therefrom qualitative and quantitative data indicative of a quality level of the fluid being measured; and analyze the sensing data, and upon identifying deviation of an operational condition of the sensing system from a predetermined normal condition, determining, based on a degree of said deviation, whether the quality level derived from the measured fluid quality data is affected by said deviation, and determine data indicative of a relation between the measured fluid quality data and sensing quality of said sensing system; and generate corresponding output data to be communicated to a local controller of said monitoring system, said output data being indicative of operational data for said sensing system aimed at initiating one or more of the following: generation of alarm signal indicative of an abnormal condition of the quality of the fluid being monitored, correction of the measured fluid quality data in accordance with the sensing quality; and replacement of one or more elements of the sensing units of said sensing system.

The control system may be configured as a central control system connected to a communication network for data communication with more than one of the monitoring systems. Such central control system further comprises a data input utility configured to be responsive to request data from each monitoring system and configured to identify the monitoring system that has initiated said request data via an identification code assigned to said monitoring system.

According to yet another broad aspect, the invention provides a method for monitoring quality of a fluid, the method comprising:
providing data indicative of measurements obtained in one or more sensing sessions performed on the fluid by at least one electro-optical sensing unit and at least one optical sensing unit, said data indicative of the measurements comprising measured fluid quality data indicative of multiple parameters of the fluid and data indicative of operational condition of at least said at least one optical sensing unit corresponding to sensing quality in said one or more sensing sessions;
determining a relation between the measured fluid quality data and the sensing quality; and
based on said relation, selectively generating operational data to initiate one or more of the following: generation of alarm signal indicative of an abnormal condition of the quality of the fluid, correction of the measured fluid quality data in accordance with the sensing quality; and replacement of one or more elements of the sensing units.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A is a block diagram exemplifying configuration and operation of a monitoring system according to some embodiments of the invention;

FIG. 1B is a flow diagram of the exemplary method of operation of a control system associated with the monitoring system of the invention;

FIG. 2 is a block diagram exemplifying configuration and operation of a monitoring system according to some other embodiments of the invention;

FIG. 3 is a schematic illustration of the configuration and operation of an exemplary optical sensing unit suitable to be used in the system of the invention for performing self-diagnostic of its operational condition;

FIGS. 4A and 4B are front and back perspective views of an exemplary monitoring system having modular configuration.

FIG. 5 exemplifies integration of the monitoring system in a fluid flow line.

FIG. 6 is a flowchart exemplifying operation of the fluid quality monitoring system according to some embodiments of the invention.

FIG. 7 illustrates an exploded view of the system of the example of FIGS. 4A-4B.

FIG. 8 illustrates the front view of the fluid sensing chambers in the system of FIGS. 4A-4B and 7.

FIG. 9 illustrates an exploded view of the exemplary examination tube suitable to be used with the monitoring system of the invention.

FIG. 10 illustrates the configuration of the exemplary optical sensing unit suitable to be used in the monitoring system of the invention.

FIG. 11 illustrates the exemplary electrode sensing unit suitable to be used in the monitoring system of the invention.

FIG. 12 illustrates a flow diagram of an exemplary process of operational session performed by the monitoring system.

FIGS. 13A and 13B illustrate, respectively, the configuration and operation of a turbidity sensing unit and a flowchart of the exemplary process for evaluating the turbidity sensing unit fault.

FIG. 14 illustrates a flowchart of exemplary process for evaluating of faulty condition of the operation of the optical sensing unit(s) and electrode sensing unit(s).

### DETAILED DESCRIPTION OF EMBODIMENTS

The terminology used herein is for the purpose of describing particular embodiments only and is not intended to be limiting of the invention.

In describing the invention, it will be understood that several techniques and steps are disclosed. Each of these has an individual benefit and each can also be used in conjunction with one or more, or some cases all, of the other disclosed techniques. Accordingly, for the sake of clarity, this description will refrain from repeating every possible combination of the individual steps in an unnecessary fashion.

Nevertheless, the specification and claims should be read with the understanding that such combinations are entirely within the scope of the invention and the claims.

Fluid quality monitoring system and method are discussed herein. In the following description, for purposes of explanation, numerous specific details are outlined to provide a thorough understanding of the present invention. It will be evident, however, to one skilled in the art that the present invention may be practiced without these specific details.

The present invention will now be described by referencing the appended figures representing the embodiments of the invention.

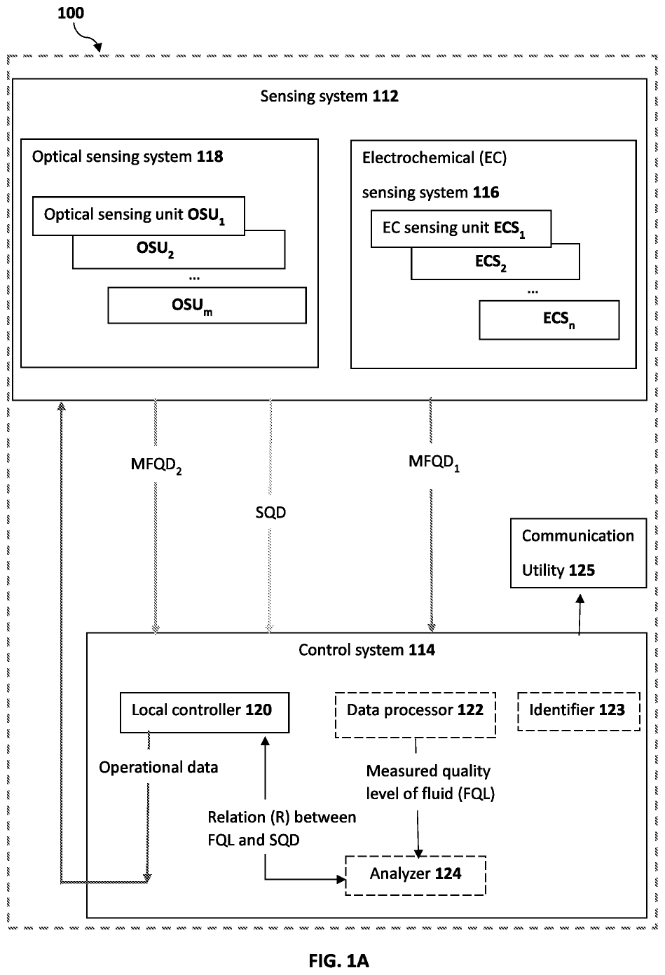

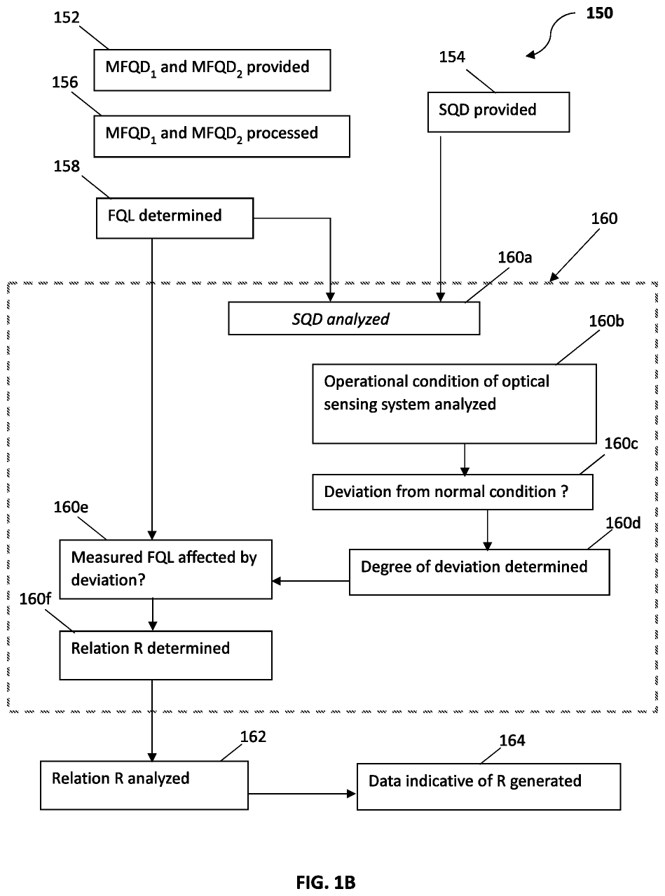

Referring to FIG. 1A, there is exemplified, by way of a block diagram, the configuration and operation of a monitoring system 100 according to the invention. The system is configured to monitor the quality of a fluid, which is typically located in a fluid chamber (which may or may not be a fluid flow line).

The monitoring system includes a sensing system 112 and a control system 114. In the example of FIG. 1A, the monitoring system 100 is configured as a fully- or almost fully-autonomous system in the meaning that it is capable of performing measurement/sensing sessions and also performing complete or partial analysis of the measurement results.

The sensing system 112 includes multiple (generally at least two) sensing units of different types configured to measure multiple parameters of the fluid and generate corresponding measured fluid quality data FQD and to perform self-diagnostic of an operational condition of the sensing system and generate sensing data indicative of sensing quality SQD. The control system 114 includes a local controller 120 which is configured to be responsive to data indicative of a relation R between the measured fluid quality data and the sensing quality data and selectively generate operational data to initiate one or more of the following: generation of alarm signal indicative of an abnormal condition of the quality of the fluid, correction of the measured fluid quality data in accordance with the sensing quality; and replacement of one or more elements of the sensing units.

As shown in the figure, the sensing system 112 includes an electrochemical sensing system 116 including N (N≥1) electrochemical sensing units—sensing units ECS₁, ECS₂ . . . ECSₙ being exemplified in the figure. The electrochemical sensing unit(s) may be of any known suitable type and their configuration and operation do not form part of the present invention. Some examples of the configuration of such sensing unit will be described further below. The electrochemical sensing system (N sensing units) generates first measured data being fluid quality data MFQD₁.

The sensing system 112 further includes an optical sensing system 118 including M (M≥1) optical sensing units—sensing units OSU₁, OSU₂ . . . OSUₘ being exemplified in the figure. The optical sensing unit(s) may be of any known suitable type. Each optical sensing unit is configured to illuminate a region of the fluid and detect light returned from the illuminated region (transmission and/or reflection and/or scattering). The detected light is thus indicative of the optical response of the fluid to the illumination (e.g. absorbance, fluorescence and scattering of light) indicative of material-related parameters of the fluid contents. Thus, the optical sensing system (M sensing units) generates second measured data being fluid quality data MFQD₂.

The optical sensing unit(s) is/are exposed to the fluid being measured via optical window(s). As will be described further below, such optical windows may be constituted by respective elements of the optical sensing unit and/or by optically transparent portions of a fluid chamber. According to the invention, the optical sensing unit(s) is/are configured to provide data indicative of optical properties of the respective optical windows, which data is indicative of the sensing quality data SQD. Some examples of the configuration of the optical such sensing unit will be described further below.

As described above, the control system 114 includes the local controller 120 which is responsive to data indicative of the relation between the measured fluid quality data and the sensing quality. Also, the control system may include an identifier utility 123, which is configured to automatically identify (e.g. via data communication with the sensing system) the type(s) of the sensing unit(s), e.g. at least of the optical sensing unit(s). Considering that the optical sensing unit(s) has selected operative spectra, by identifying the type of the optical sensing unit(s), control system identifies the parameter(s) of the fluid to be measured and can perform interdependent correlations.

As also mentioned above, in the example of FIG. 1A the monitoring system 100 is configured to perform complete or partial analysis of the measurement results provided by the sensing system. The control system 114 thus includes either one or both of a data processor 122 which processes the measured fluid quality data MFQD₁ and MFQD₂ and derive therefrom qualitative and quantitative data indicative of a quality level FQL of the fluid being measured, and an analyzer 124 which is configured to analyze the sensing quality data SQD and measured fluid quality level FQL and determine the relation R between the measured fluid and sensing qualities. In case the control system 114 includes one of the processor and analyzer 122 and 124, the functions of the other one of the processor and analyzer 122 and 124 is performed by a remote central system (not shown here), with which the monitoring system 100 communicates via a communication utility 125.

It should be noted that the configuration of the control system 114 may be such that the local controller 120 is integral with the sensing system 112, while the data processor 122 and the analyzer 124 are parts/utilities of a separate computer system which is in wireless data communication with the sensing system 112 (using any known suitable wireless communication configuration and protocols). Thus, generally, the control system 114 may be associated with a given monitoring system 100, while its functional utilizes may be partly integral with the sensing system and partly located in a separate computer system.

It should also be noted that the data processing and analyzing may be performed in a so-called “on-line mode”, i.e. while performing measurements or in an off-line mode, i.e. at times (according to a predetermined time pattern) accessing pre-stored measured data and performing its processing and analyzing as described above. Thus, the local memory utility of the sensing system, or a separate storage device associated with the sensing system as the case may be, actually presents a measured data provider for the data processor and analyzer utilities of the control system.

It should be noted that, irrespective of whether the system 100 is configured as fully- or partially-autonomous or not (i.e. includes only the local controller 120), the system 100 is anyway preferably configured to communicate with the remote central system to cloud computing technique (including machine learning and artificial intelligence data processing) utilizing similar measured and sensing data obtained at multiple other similar monitoring systems.

FIG. 1B exemplifies a flow diagram 150 of the operation of the control system 114. Measured fluid quality data MFQD₁ and MFQD₂ is provided (step 152) and measured sensing quality data SQD is provided (step 154), as described above. The measured fluid quality data MFQD₁ and MFQD₂ is processed (step 156) and a fluid quality level FQL of the fluid being measured is determined (step 158). As described above, the analyzer utility 124 is configured to analyze the sensing quality data SQD and the measured fluid quality level FQL and determine the relation R between the measured fluid and sensing qualities (step 160). More specifically, the analyzer 124 is configured to analyze the sensing data SQD (provided by the optical sensing unit(s)) and determine and analyze the corresponding operational condition (e.g. the optical properties of the optical windows)—steps 160a and 160b. Upon identifying deviation of the operational condition of the sensing system from a predetermined normal condition (step 160c), and determining a degree of the deviation (step 160d), the analyzer performs a decision making procedure to decide whether the qualitative and quantitative data (fluid quality level data) derived from the measured fluid quality data MFQD_{1,2} is affected by such deviation (step 160e), and determines the relation data R between the measured fluid quality data MFQD_{1,2} and the sensing quality data SQD (step 160f).

The relation R is analyzed (step 162) and data indicative of the relation data R is then generated (step 164) to be communicated to the local controller to be used by the local controller 120 to define the operational data, i.e. generation of alarm signal indicative of the abnormal condition of the quality of the fluid, instruction to the data processor to correct the measured fluid quality data based on a correction factor (derived from the relation R) in accordance with the sensing quality, and replacement of one or more elements of the sensing units.

For example, in case the relation value R is above (or below) a certain predetermined threshold, the data indicative of the relation R corresponds to the condition that the optically measured fluid quality data MFQD₂ is not reliable anymore and one or more elements of the sensing unit(s) is/are to be cleaned/replaced. In case the relation value R is within a certain predetermined critical range, the data indicative of the relation R corresponds to that a correction factor is to be determined (defining a compensable degree of unreliability of the optically measured fluid quality data) and is to be applied to at least optically measured fluid quality data MFQD₂ to enable determination therefrom of meaningful water quality parameters.

It should also be noted, although not specifically illustrated in the flow diagram of FIG. 1B, that by using machine learning and AI enables to determine a relation R′ between dynamics of degradation of optical and electrochemical systems (for given sensing units used in such systems and given type of fluid being measured). By this, upon identifying the degree of deviation of the operational condition of the optical sensing unit(s) from a predetermined normal condition, the relation R′ is used to evaluate unreliability of the electrochemically measured fluid quality data MFQD₁ and determine a corresponding correction factor to be applied to the measured data.

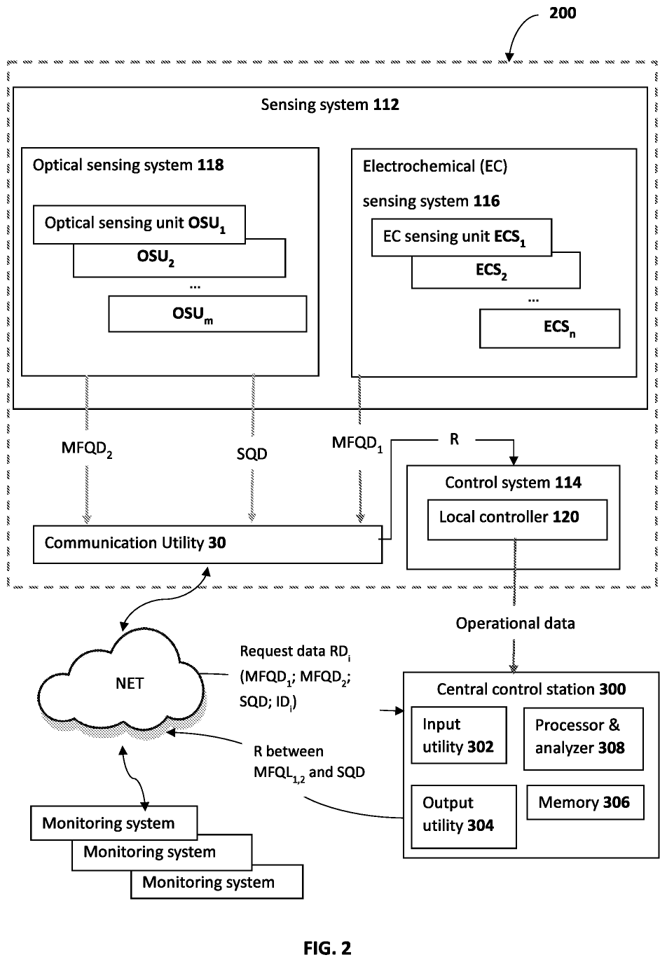

Referring to FIG. 2, there is illustrated another example of the configuration of a monitoring system 200. To facilitate understanding, the same reference numbers are used to indicate functionally similar parts of the system in both examples. Thus, system 200 of FIG. 2 is configured generally similar to the above-described system 100, namely includes the above-described sensing units of different types capable of measuring multiple parameters of the fluid and generate corresponding measured fluid quality data MFQD₁, MFQD₂ and capable of performing self-diagnostic of the operational condition of the sensing system and generating corresponding sensing quality data SQD; and includes the control system 114. In the system 200, the control system 114 includes the local controller 120 which is configured to communicate the measured and sensing quality data MFQD₁, MFQD₂ and SQD to the remote central system 300 via the communication utility 125 and is responsive to data indicative of the analysis results (relation R) from the central system 300 to generate the operational data. To this end, the monitoring system 100, 200 has its assigned identification code ID, and the controller 120 generates request data RD to be communicated to the central system 300 which includes the measured fluid and sensing quality data MFQD₁, MFQD₂, SQD and the identification code of i-th monitoring system IDᵢ.

The central control system 300 is connected to a communication network and configured for data communication with multiple fluid quality monitoring systems. In other words, the control system 114 of the monitoring system 100, 200 is configured as a node of a fluid network formed by a plurality of similar monitoring systems connectable via a communication network. The central control system 300 is configured as a computer system comprising inter alia data input utility 302, data output utility 304, memory 306, and a data processor and analyzer utility 308. The central processor and analyzer utility 308 includes functional utilities of the data processor 122 and analyzer 124 described above.

The data input utility 302 is responsive to request data RDᵢ from each i-th monitoring system from the multiple fluid quality monitoring systems having subscription to such central services, and is configured to identify the fluid quality monitoring system that has initiated the request data via the identification code assigned to said monitoring system. The central data processor and analyzer 308 is configured to identify, in the request data RDᵢ, the measured fluid quality data and sensing data (MFQD₁)ᵢ, (MFQD₂)ᵢ, (SQD)ᵢ, and perform the following data processing:

Similar to the above described operation of data processor 122, at least the optically measured fluid quality data (MFQD₂), is analyzed to derive therefrom qualitative and quantitative data indicative of a quality level of the fluid, FQL, being measured. Similar to the above-described operation of the analyzer 124, the sensing quality data (SQD) is analyzed to identify deviation of an operational condition of the optical sensing system of the i-th monitoring system from a predetermined normal condition. To this end, the processor 308 utilizes apriori known (pre-stored) configuration data of the respective i-th sensing system, e.g. optical scheme utilized in the optical sensing unit, number and arrangement of the optical sensing units, the number and type of light source(s) and detector(s), etc.

In order to evaluate a change in the optically measured fluid quality data (MFQD₂)ᵢ that can be associated with a change in the sensing quality data (SQD)ᵢ machine learning technique can be used, which utilizes the history of measurements performed by the specific sensing system on a specific fluid type, and a predetermined expected dynamics in the measurements taken over time. For example, machine learning techniques that may be used in the system of the invention include XGBOOST and random forest for multi variable regression; and ANN and LSTM for deep learning. Also, unsupervised learning technique can be used, such as clusters and k-means, to find abnormality in the data.

For example, measured fluid quality data, e.g. optically measured data MFQD₂, includes multiple data pieces corresponding to parameters of various substances (e.g. contaminants) in the fluid. This may be a spectral signature formed by optical responses of various substances contained in the fluid. A relation between such multiple data pieces (or measured signals defining a spectral signature) defines a quality level of the fluid measured under a given status of the measured fluid quality data, i.e. given operational condition of the optical sensing unit(s). Thus, the operational condition of the optical sensing system affects the relation between the multiple data pieces.

A model-based processing provides for identifying (e.g. via iterative fitting of measured data to model data) a mismatch between the measured optical signature and reference data (various reference signatures corresponding to various fluid quality conditions). Such mismatch may be indicative of some unreliability of optically measured fluid quality data. On the other hand, a deviation of the operational condition of the optical sensing system might be a source of such mismatch.

Hence, a relation is determined between the sensing quality data SQD (i.e. degree of the deviation in the operational condition of the optical sensing system from the normal condition) and the optically measured fluid quality data MFQD₂ (i.e. a level of mismatch in the optically measured fluid quality data), and this relation is analyzed (compared to predetermined thresholds and ranges as described above) to determine a correction factor to correct the optically measured fluid quality data for further analysis of the real quality for an abnormality condition, or one or more parts of the optical sensing system are to be replaced. The data processor and analyzer 308 generates corresponding output data to be communicated to the local controller 120 of the i-th monitoring system.

As described above, the data processor and analyzer 308 may also be configured to utilizes machine learning techniques to determine the relation R′ between the dynamics of degradation of optical and electrochemical systems (for given sensing units used in such systems and given type of fluid being measured), and thus evaluate the level of unreliability of the measured electrochemical fluid quality data MFQD₁ with the identified deviation of the operational condition of the optical sensing unit(s).

As also described above, the functional utilities of the data processor and analyzer 122-124, 308 may be distributed between the control system of the monitoring system and the central control system.

The optical sensing system 118 preferably utilizes multiple illumination wavelengths to detect optical responses of two or more substances in the fluid. Generally, multi-spectra measurements can be implemented using a broadband illuminator and spectrometer. Practically, however, and especially to enable modularity of the monitoring system configuration and simplify the maintenance, the optical sensing system includes an array of separate sensing units each including a light source device and a detection device, equipped with suitable optical assemblies.

Preferably, the optical sensing unit includes a light source device including one or more light sources configured to generate one or more illuminating wavelength ranges to illuminate the fluid and cause light response of the fluid; and an optical detector device including one or more detectors configured to detect light of one or more wavelengths and generate the optically measured fluid quality data MFQD₂ indicative of the one or more contaminants in the fluid. Preferably, the light sources include light emitting diodes (LEDs).

The following table exemplifies some physicochemical parameters that can be measured using various optical schemes:

| | | Main light | |
|---|---|---|---|
| Parameter | Technique | source wavelength | |
| N-NO3 | Absorbance | ~230 nm (Additional wavelength | |
| | | may be required to compensate for | |
| | | cross absorbance of other water | |
| | | constitutes) | |
| TOC (total | Absorbance | 275 | nm |
| organic carbon) | | | |
| UVT-254 | Transmission | 254 | nm |
| Turbidity | Scattering or | >750 nm (Different standards for | |
| | scattering | turbidity measurements may require | |
| | and transmission | different light sources) | |
| Assimilable | Absorbance | 255 | nm |
| organic carbon | | | |
| Apparent color | Absorbance | Visible light | |
| Alkalinity | Absorbance | IR | |
| Oil in water | Fluorescence | UV | |
| NO2 | Absorbance | <230 | nm |

| | | |
|---|---|---|
| Chlorophyll | Fluorescence | UV |
| Cyanobacteria | Fluorescence | UV |

As described above and will be exemplified more specifically further below, the optical sensing unit is preferably configured to detect light transmitted through/reflected from the fluid region and optical window assembly(ies) and also light scattered from the optical window assembly(ies).

In this connection, it should be understood that “optical window assembly” is formed by at least one optical window in the illumination path (e.g. optical window(s) interfacing with an output of a light source device or an optical guiding unit at the light source side, as the case may be) and at least one optical window at the light detection path. Considering the transmission mode, each of the illumination channels may include a single optical window being a part of the optical sensing unit in case the optical sensing unit is located inside the fluid chamber, or may also include an additional optical window constituted by a transparent portion of the fluid chamber.

The transmission/reflection measurement mode is aimed at measuring the fluid quality and possibly also at monitoring transmission properties of the optical window assemblies. The scattering measurement mode is aimed at monitoring the transmission properties of the optical window assemblies and also scattering properties of the fluid.

To this end, a detection device includes at least one detector configured (e.g. has spectral properties) and accommodated (with respect to orientation of the illumination path) to detect light returned from the fluid, i.e. light response of the fluid to the illumination; and at least one detector configured and accommodated to perform a so-called “dark field” detection, i.e. detect light components of the illumination light propagating from the optical window at angles other than those of specular reflection angles.

For example, a light sensitive surface of the transmission mode detector (bright field detector) is located in a plane perpendicular to the illumination path (i.e. the detection path is parallel to the illumination path), while a light sensitive surface of the scattering mode (dark field) detector is oriented substantially parallel to the illumination path. Such configuration allows on the one hand detection of light scattered from the optical window which is indicative of a level of dirtiness of the optical window, and on the other hand allows to measure turbidity of the fluid.

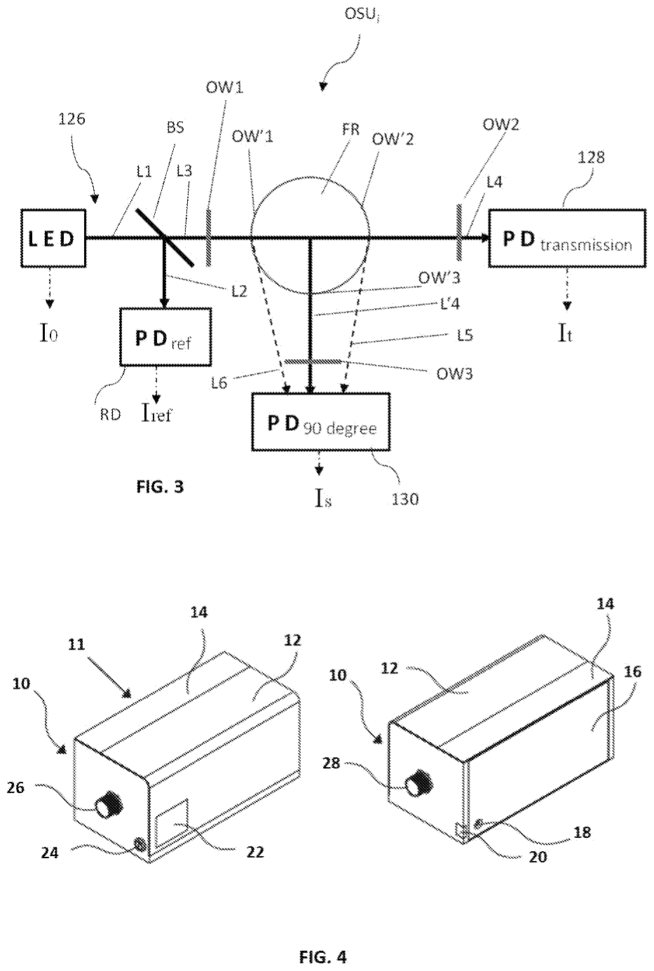

The above is schematically exemplified in FIG. 3, shown i-th optical sensing unit OSUᵢ including a light source device 126, which in the present example is constituted by LED(s), and a detection unit including a transmission mode detector 128 and a scattering mode detector 130. The light source device is also preferably configured to define a reference scheme. To this end, a beam splitter BS is provided in an illumination path deflecting light incident thereon towards a reference light detector RD.

Light source device 126 generates illumination light L₁ propagating to the beam-splitter BS which reflects a part L₂ of this light to the reference detector RD and transmits the other part L₃ to propagate to interact with the fluid in the fluid region FR, while successively interacting via an optical window OW₁ (output facet of the light source device) and an optical window OW′₁ (transparent portion of the fluid chamber). Light components L₄ and L′₄ returned from the fluid as a result of such interaction of light components L₃ with the fluid propagate, respectively, towards so-called “transmission detector” 128 via respective optical windows OW′₂ and OW₂ in the “transmission” detection path, and towards so-called “90 degree detector” 130 via respective optical windows OW′₃ and OW₃ arranged along an axis perpendicular to the illumination path. The detector 130 also detects light components L₅ and L₆ scattered from the optical windows OW′₁ and OW′₂. As noted above the “90 degree detector” exemplified here is a “scattering detector” and the use of a 90 degrees detector is a not limiting example; the scattering angle to be detected may be any non-specular reflection angle. The operation of such optical sensing unit for turbidity measurements will be described further below.

It should be understood that the so-detected dirtiness level of the optical windows OW′₁ and OW′₂ can be used to evaluate the sensing quality of the optical sensing unit. Indeed, it is generally known in that scattering of light caused by turbidity is predominantly Rayleigh scattering, while scattering of light that is caused by sediments and other contaminants (generally, particles) on a surface (optical window in this case) is different. Detection of light scattering from the optical windows can be enhanced by using polarized illumination, since light interaction with particles destroys the polarization. Thus, utilizing the different scattering mechanisms coupled with polarization dependencies, and measurement of additional physicochemical parameters such as temperature, allows to apply proper machine learning and AI techniques to distinguish between detected scattered light associated with the light-fluid interaction and light-surface interaction, and by this identify the scattering origin.

Reference is now made to FIGS. 4A and 4B which illustrate the front and back perspective view, respectively, of an exemplary fluid quality monitoring system 10 according to some embodiments of this invention. The system is configured as the above described system 100 or 200, namely includes the sensing system and the control system.

The monitoring system includes a housing 11 having a generally box-like geometry containing operational parts of at least the sensing system. Generally, the control system may be physically separated from the sensing system and may be configured for wireless data communication with the sensing system. Practically, however, the functional utilities (hardware and/or software) of the control system (including at least the local controller) may be incorporated with the sensing system inside the housing.

The housing is formed with a top cover 12 that is attached (e.g. by hinges) and can be opened to provide access to various elements of the system 10 accommodated in a respective compartment inside the housing. Also provided on the top surface of the housing is a panel 14 that can be opened to provide access to electronic components of the system located in another compartment inside the housing. A window 22 is formed on a front facet of the housing 11 and provides a view of a display panel (not shown here) that will be described in more details further below. Alternatively or additionally, a display panel may be located on the top cover 12.

The system may be powered using a battery 16, which may be a rechargeable battery that can be charged through a power socket 18, or may be replaceable by pushing a button 20. The power supply such as battery 16, but not limited to, provides necessary electrical power to operate all the elements/components of the sensing units as well as other operational components of the system that share a common power connection and can include one or more of the following: direct connection to a power grid, a battery, a capacitor, a solar collector, a device configured to draw power from a flow of fluids in a fluid line, a charge configured to charge a battery while power from an external source is available, etc.

The power socket 18 is configured to receive a connector from a power cable or is configured to provide power directly to the respective components without the need of battery 16.

A locking mechanism 24 may be provided to prevent opening of the lid 12 and thus prevent all tampering with the system 10.

In some embodiments, the housing 11 is formed with a threaded fluid inlet 26 and can be connected to a fluid supply line.

It should be understood that the system 10 may be installed in any of a number of locations enabling the relevant elements/components of the sensing units to be properly exposed to the fluid in a fluid chamber that is to be measured. These locations may include, but not limited to, water utility, water station, water supply line to residence or business in the vicinity of water meter, water supply lines inside a building in multiple locations, water supply line of an apartment, effluent discharge line of a treatment facility, on an underground valve or pipe, at a line where residential effluent leaves a residence septic tank, on the feeder line of hydroponic feeding solution, on the discharge line of hydroponic farm, etc.

It should be understood that the fluid under measurements in the fluid chamber may or may not be flowing, i.e. may or may not be a fluid flow line.

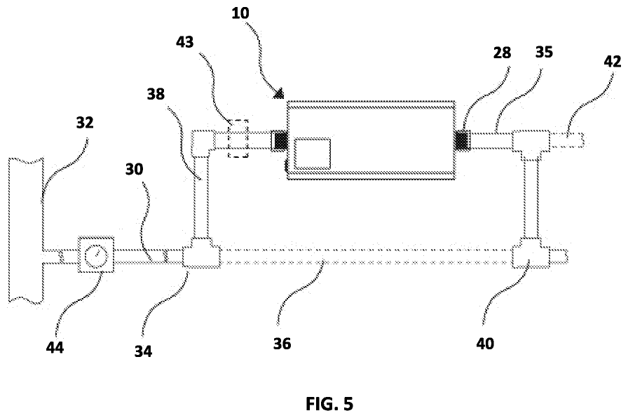

Referring now to FIG. 5, there is exemplified that the fluid quality monitoring system 10 may be integrated into a fluid line 30, such that the fluid coming/flowing from a main fluid source 32 is directed to flow through a fluid path defined by the system 10 (fluid path passing the sensing system). The main fluid source 32 may be municipal utility water system, building water system, agricultural water system, effluent from a treatment facility, etc.

For example, the system 10 is incorporated into a bypass line 35 of the fluid line through a T-junction 34 and via a feeder line 38. The configuration is such that most of the fluid continues to flow through a main fluid line 36 and a portion of the fluid flows through the bypass line 35.

The separated fluid portion flows through the system 10 and out of the outlet 28, and in some embodiments it returns to the main fluid line 36 through a T-junction 40, while in some other embodiments the fluid portion does not come back to the main fluid line 36 but is discarded through a line 42. According to some embodiment, the fluid portion flowing through the line 42 is discarded into a wastewater line (not shown).

As shown in the figure in dashed lines, an optional control valve 43 may be positioned between the feeder line 38 and the system 10. According to some embodiments, the operation of the valve 43 may be electronically controlled by a respective controller provided in the system 10. Also, in some embodiments, the control valve 43 may be positioned at the outlet 28 of the system 10. In some embodiments, two control valves can be positioned in the bypass line 35, one being upstream and the other downstream of the system 10.

Additionally, and optional flow-meter 44 can be used being positioned in the feeder line 38 between the fluid source 32 and the system 10. In some embodiments, the flow-meter 44 may be connected to the system 10, providing flow information to the control system.

It is further recognized that at certain integration location the fluid flow from the fluid source 32 can be not constant, and data provided by the flow meter 44 can be used to notify/instruct the system 10 to close valve 43 and stop the measurements in case the flow meter 44 detects zero or low flow. In some embodiments, the flow meter 44 can be incorporated into the system 10.

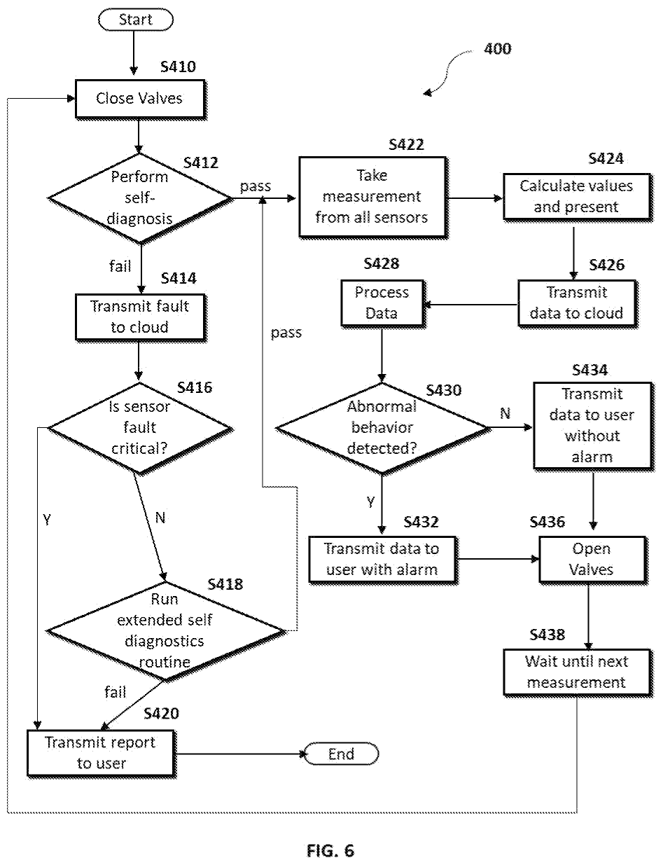

Referring to FIG. 6 there is illustrated a flowchart 400 exemplifying the operation of the fluid quality monitoring system (e.g. configured as the above-described system 10) in accordance with some embodiments of the invention.

For example, the system 10 (its valve controller) can first operate to closes the valve(s) 43 (step S410) so that the separated fluid portion is stationary inside the system. The valve closing step S410 is optional, and the same can be achieved without closing the valves.

Then, the system 10 operates to perform a preliminary self-diagnostic procedure to determine whether all the sensing units are properly operated (step S412). If the output of such preliminary self-diagnostic procedure is ‘fail’, the system 10 operates to transmit the fault signal to the control system, e.g. to the central control system/cloud (step S414). Generally, the self-diagnosis routine can be used to check one or more of the following: nominal intensity of the light source(s), e.g. LEDs, with a reference photodiode. current drawn by LEDs, temperature in a normal range, measurements from another photodiode(s) without illumination, self-check of electrochemical sensors, as well as one or more other relevant parameters (e.g. flow, pressure, etc.).

Then, the fault data is analyzed to determine whether the fault is critical (step S416). If the fault is deemed to be a critical fault, the system generates and transmits to user a corresponding report/notification (step S420). If the fault is not critical, the system 10 runs an extended self-diagnostic routine of the sensing units, and if such extended routine fails, a report is generated and transmitted to the user (step S420).

If the preliminary self-diagnostic at step S412, or the extended self-diagnostic at step S418 passes, the system 10 operates to take measurements from all the sensing units installed in the sensing system (step S422), and fluid quality data MFQD₁ & MFQD₂ (electro-chemical and optical data) and optical sensing quality data SQD are provided and analyzed (step S424), e.g. internally by the control system of the monitoring system 10 and the results may be presented on the display panel.

Then at step S426, the system 10 transmits all the data to the cloud (central control system), where all the data is processed (step S428), e.g. using model based processing and correlation to historical data and/or correlation to data from other monitoring systems installed in a fluid network, as described above.

Then, in step S430, the analyzer (at the central system in the present not limiting example) analyses the processing results to decide whether abnormal behavior in the fluid data is detected. If an abnormal fluid behavior is detected, the data is transmitted to the local controller which generates an alarm signal (step S432). If the fluid appears to satisfy normal/acceptable condition, respective data is transmitted to the user, e.g. via the local controller (step S434).

In case the above measurement procedures were performed after closing the valves, the valves are now opened (step S436).

Then, the system 10 “waits” the required/predetermined time (step S438) until the next measurement session (starting from step S410 or directly from step S412).

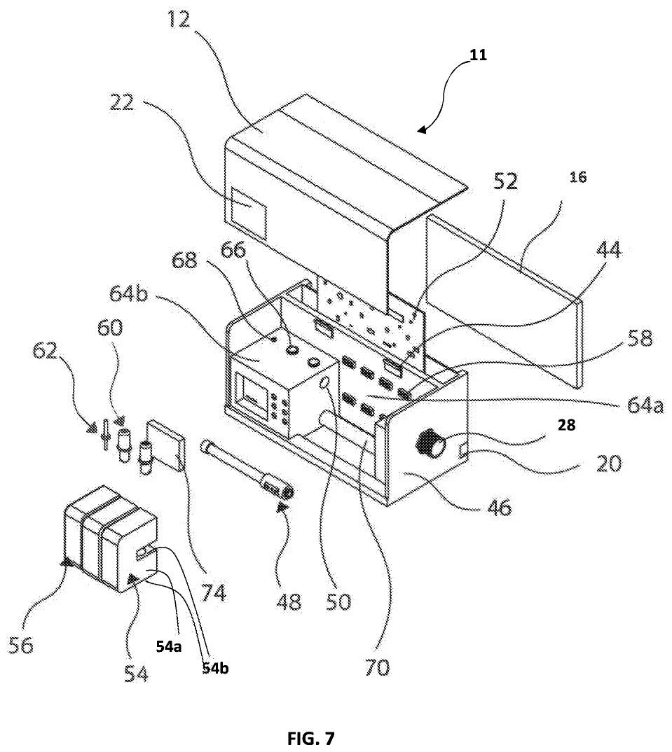

As described above, the monitoring system of the present invention has a modular configuration facilitating assembling/dissembling of the system and also enabling replacement of various elements of the system. FIG. 7 illustrates an exploded view of the exemplary monitoring system 10 showing more specifically the configuration of the sensing system located inside the housing 11 (having a body 46 and a cover 12). As shown, the sensing system includes a chamber 64a configured to receive/assemble therein the optical sensing system including at least one optical sensing unit 54 and/or 56 and an examination tube (fluid chamber) 48. In this non-limiting example, the examination tube 48 is configured to be detachably mounted in the housing. The examination tube 48 has at least partially transparent portion presenting an optical window such that optical measurements can be performed on the fluid that flows through the examination tube 48 via the optical window.

In some embodiments, a bore 50 is provided that resides in the examination tube receiving chamber 64a and has a spring mechanism (not shown) that allows for easy replacement of the examination tube 48. A gasket or other appropriate sealing element (not shown) may be provided inside the bore 50 and the examination tube 48 so as to provide a moisture-proof barrier to prevent fluids that flow between to spill out. Configuration of the examination tube 48 will be described in more details further below.

As further exemplified in the figure, the monitoring system 10 includes a chamber 64b disposed within a body 46 of the housing 11 along the fluid path. The chamber 64b is configured to receive/assemble therein the electro-chemical sensing system including at least one electrode sensing unit 60 (constituting electro-chemical sensing unit). It should be understood, although not specifically shown here, that the electrode sensing unit(s) is/are assembles in the housing (in the respective module(s)/compartment(s) of the housing) such that an active part of the sensing unit (electrode(s)) is exposed to the fluid being measured, i.e. interacts with the fluid.

The control system including at least one electronic PCB module 52 is located inside the main housing body 46. The electronic PCB module 52 may include multiple modules such as, but not limited to, a logic/decision module (the local controller and possibly also the data processor and analyzer as described above), a CPU module, memory, as well as a power module, a wireless module (including communication utility, a wired module, ADC module, DAC module, etc.).

Different electronic PCB modules 52 may be installed in separate compartments/slots (not shown) inside the main housing body 46. This allows a user to choose appropriate PCB modules 52 to be installed.

The optical sensing unit 54 (or 56) has a generally U-shaped configuration such that when the optical sensing unit(s) is/are installed in the chamber 64a a portion of the examination tube (fluid chamber) is located in an inner cavity/slot 54a of the U-shaped structure. The light source device and the detection device (not shown) are located in the arms/legs 54b of the U-shaped structure to define the illumination and detection paths as described above and exemplified in FIG. 3. As also shown in the figure, electrical connectors 58 to the optical sensing unit(s) are provided in the main body 46, such that when the optical sensing unit 54 (or 56) is/are assembled in the body they are aligned with the connectors 58.

There are several suitable types of U-shaped optical sensing unit structures. This will be exemplified more specifically further below.

The U-shaped optical sensing unit structures 54 and 56 are easily mounted such that the examination tube 48 (fluid chamber) is at least partially embraced by the U-shaped structure. It will be recognized that other configurations to mount the optical sensing units 54 and 56 with respect to the fluid chamber 48 are possible, in order to enable, on the one hand, light fluid interaction for measurement of the fluid quality parameters and self-diagnostic of the optical properties of optical windows involved in the optical measurements.

As described above, according to some embodiment, the system 10 is capable of automatically identifying the kind (configuration data) of the optical sensing units 54 and 56 that are installed and automatically update the data processing software.

A person skilled in the art should readily understand that such plug & play configuration of the fluid quality monitoring system 10 allows the user to choose which fluid quality parameters are to be optically measured at a certain given location where the system 10 is installed. In addition, a plug & play configuration allows the user to replace the faulty optical sensing unit(s), as well as elements thereof (light source and/or detector and/or optics), without loss of time.

Similarly, several different electrode sensing units can be installed into the chamber 64b—two such electrode sensing units 60 and 62 being shown in the figure. The configuration and operation of the electrode sensing units will be described in more detail further below.

The electrode sensing units 60 and 62 are mounted/assembled in bores 66 and 68 such that the electrode sensing units are exposed to the fluid that is located/flows through the chamber 64b. It will be recognized that other configurations to mount the electrode sensing units are possible.

A gasket or other appropriate sealing elements (not shown) may be provided between the rim of electrode sensing units 60 and 62 and the upper surface of the mounting so as to provide a moisture-proof barrier to prevent liquids to pass.

The control system may be configured to automatically identify the kind of electrode sensing units 60 and 62 that are installed and automatically update the data processing software.

Similar to the optical sensing units, the plug & play configuration of the system 10 allows the user to choose which fluid quality parameters are to be measured by electro-chemical sensing system at a given location where the system 10 is installed, as well as allows the user to replace faulty electrode sensing unit(s) or one or more elements thereof.

Referring now to FIG. 8 there is illustrated the front view of the exemplary fluid quality monitoring system 10. In this example, the examination tube 48 (fluid chamber) is accommodated inside the chamber 64a of the optical sensing system and at least partially embraced inside the U-shaped structure of the optical sensing unit(s) 54 which have their associated electrical connectors 58.

The control valve (not shown) is located downstream of the fluid inlet 26 and its operation (opening and closing on demand) is controlled by the system 10.

It should be noted, although not specifically illustrated that inside the fluid sensing system, the fluid portion to be measured may be divided at a T-junction (internal T-junction of the sensing system), such that some of the fluid continues its flow through the fluid path towards the electro-chemical sensing chamber 64b and towards the optical examination tube 48, while the rest of the fluid is diverted into a parallel bypass fluid tube 70. By this, the pressure in the examination tube 48 is reduced. This fluid tube 70 may be made partially from transparent material and used for further calibration or correlation purposes.

In some embodiments, the fluid portion that continues to flow after the T-junction to the fluid path in the monitoring system, flows through the electro-chemical examination chamber 64b in which the electrode sensing units 60 and 62 can be installed. For example, the electrode sensing units 60 and 62 are screwed on the threaded bore 72. The threaded bores 72 for the electrode sensing units 60 and 62 can be of different sizes to accommodate different size electrode sensing units 60 and 62, such as but not limited to pH sensor, temperature sensor, ORP sensor, EC sensor, Ion-selective electrode sensors, etc.

The display panel 74 (e.g. LCD display) is preferably provided being located inside the main housing body 46, in such a way that it can be seen through the viewing window on the front lid when the lid is closed (as described above). In such case, the display panel is protected from the outside by the front lid.

The display panel 74 provides information related to user-selected options and fluid quality and sensing quality measurements.

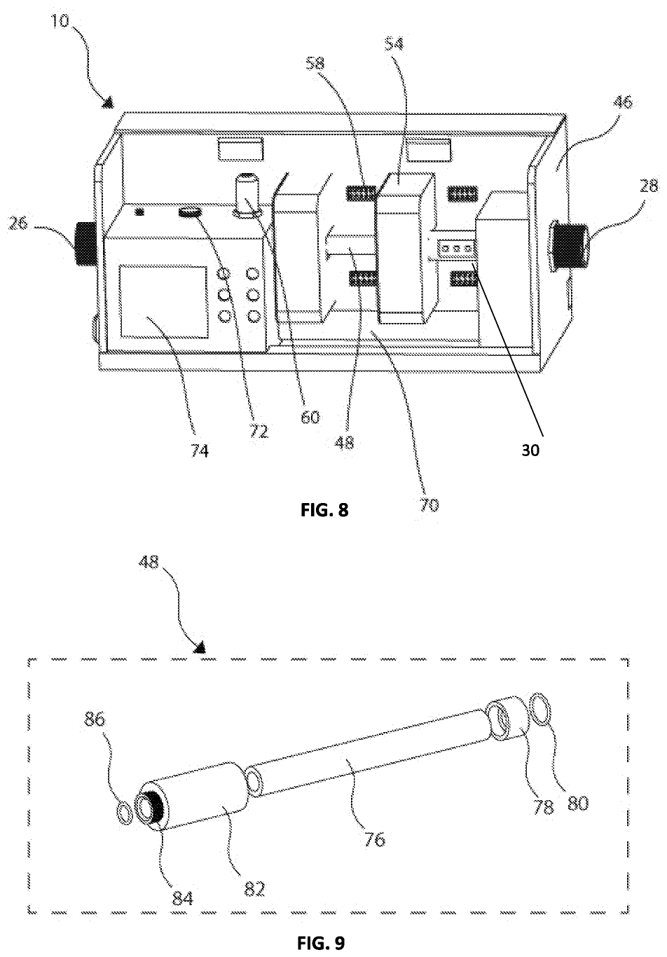

FIG. 9 illustrates an exploded view of the exemplary examination tube 48 (fluid chamber) that may be used with the fluid quality monitoring system. The examination tube 48 has a portion 76 that is at least partially transparent for the spectral range(s) used in the optical measurements to be performed on the fluid that is contained in/flows through the examination tube 48. The transparent portion 76 of the fluid chamber 48 can be made of any kind of suitable material including transparent plastics, glass, and quartz.

In some embodiments, making the transparent portion 76 from quartz is preferred since this also allows UV-C measurements through such transparent portion (because glass absorbs UV-C light).

Generally, the fluid chamber 48 may be of any suitable geometry, having circular, oval or polygonal cross-section. In the present description, such fluid chamber is exemplified as and referred to as a tube, but it should be understood that the principles of the invention are not limited to this specific example.

The transparent portion 76 of the fluid chamber may be glued to a fitting element 78, that can be pressed through a gasket 80 into the bore 50. Alternatively, the transparent portion 76 may be connected with a gasket to the fitting 78. The other side of the transparent portion 76 is glued into a fitting element 82. The fitting 82 may be formed with a threaded bore 84 on one side configured to be threaded into the main housing body 46. A gasket 86 is preferably placed between the threaded bore 84 and the main housing body 46 to provide a watertight connection.

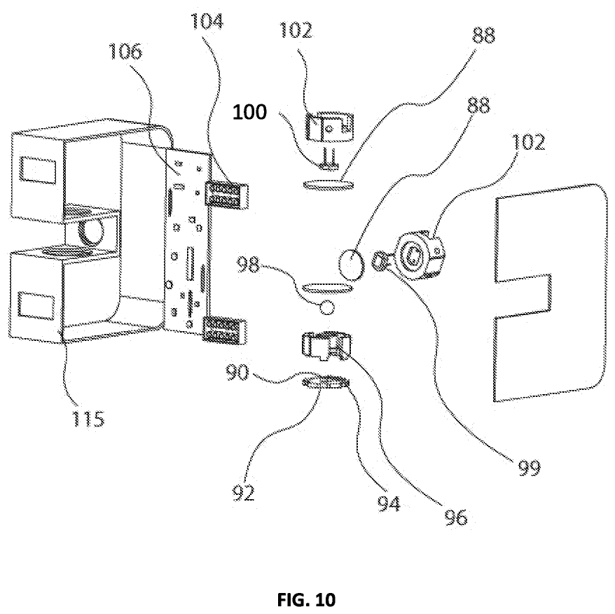

Referring now to FIG. 10, there is more specifically illustrated the exemplary U-shaped structure of the optical sensing unit 54 suitable to be used in the system 10. The U-shaped structure is configured such that illuminating light is emitted from one side of the sensing unit (one leg of the U-shaped structure) to the other opposite side (the other leg of the U-shaped structure) where the “transmitting” detector(s) is/are located, and “scattering” detector(s) is/are located at an apex region of the U-shaped structure (as generally described above with reference to FIG. 3). An opening (cavity/slot) in between the two sides of the U-shaped structure defines a fluid space, so that the measured fluid is surrounded by the emitting side and the detecting sides. This enables to measure optical properties of the fluid, in particular light absorption of the fluid, and, as described above, by properly accommodating the detectors this also allows to measure optical properties of the optical windows through which measurements are performed (including the transparent portion of the fluid chamber).

It should be noted that the optical sensing system may include more than one optical sensing units. One or more of the optical sensing units may be configured for measuring both the fluid properties and performing the self-diagnostics of the optical properties (and thus including “transmitting” and “scattering” detectors), while one or more of the other optical sensing units may be configured for only measuring the fluid properties (and might not include a “scattering” detector, while the use of such detector is anyway preferred for detecting scattering properties of the fluid). Moreover, by using an array of closely arranged optical sensing units (e.g. within a common elongated U-shaped structure), one optical sensing unit may actually detect scattered light components induced/caused by illuminating light produced by a neighboring optical sensing unit.

As shown in the figure, an optical windows 88 are located on the emitting side and the detecting sides. The optical window 88 may be made from glass or plastic, or from quartz so as not to absorb UV-C light. Also, in some embodiments, the optical windows 88 can be configured as or may be equipped with wavelength selective optical filters to filter some of wavelengths (wavelength ranges).

It should be understood that, generally, the optical sensing unit is configured to measure fluid parameters using one or more suitable light-fluid interaction techniques by illuminating/exciting the fluid and detecting light response of the fluid including either one or more of light transmission through/reflection of the fluid, fluorescence response, RAMAN response, etc. Additionally, the optical sensing unit is configured to enable detection of light response of the optical window, typically light scattering. This can be enhanced by utilizing polarized illumination. In this case, polarizer(s) may be selectively located in the illumination/detection path(s).

In some embodiments, the optical sensing unit structure has no optical windows. The purpose of the optical windows 88 is to provide protection to the elements optical sensing unit, while it will be recognized that other approaches may be used to provide said protection. However, in order to enable light-fluid interaction for the fluid located in the fluid chamber, the latter needs to be provided with the at least partially transparent portion, and such portion constitutes the optical window whose optical properties define the optical sensing quality.

In some embodiments, a light source device (126 in FIG. 3) includes may include one or more light sources single such light source 90 being shown in the figure. It should be noted that the light source device may include LED(s) and/or laser diode(s) and/or high-intensity discharge lighting source. The light source(s) is/are placed on the emitting side of the U-shaped structure. The light source device may include one or more LEDs that can be configured to emit many wavelengths, for example, but not limited to 230 nm, 234 nm, 255 nm, 275 nm, 530 nm, 632 nm, 760 nm, etc. Alternatively, the light source device may include one or more laser diodes and/or high-intensity discharge lighting source(s).

A person skilled in the art will understand that different illuminating wavelengths can be used to measure different constitutes of the fluid, for example, total organic carbon, turbidity, assimilable organic carbon, N—NO3, iron, alkalinity, etc.

The light source 90 may be thermally coupled to a heat sink 92, which dissipates heat generated by the light source 90. It is well known that generated heat might affect the performance of the light source device and its longevity. Therefore, it might be important to dissipate that heat. In some cases, however, the amount of heat generated by the light source 90 might be relatively small, and thus heat sink is not required.

In some embodiments, a temperature sensor 94 may be provided, e.g. being thermally coupled to the heat sink. Measuring/monitoring the temperature of the light source 90 allows for further calibration of the light source 90 and for early fault detection of the light source 90.

The light source 90 is fitted inside a fitting component 96. The fitting component 96 may include a lens unit 98, which may include a ball lens in a precise distance from the light source 90 in order to collimate the light beam(s) propagating from the emitting side in case that such collimation is needed.

The lens unit 98 may include one or more of a half-ball lens, spherical lens, aspherical lens, achromatic lens, etc. The lens can be coated with an anti-reflection coating.

The detection device located at the receiving/detecting side of the one-path U-shaped structure of the optical sensing unit includes light detectors (similar to detectors 128 and 130 in FIG. 3), which may include photodiodes—one of such photodiodes 99 being shown in the figure, located inside a fitting component 102. The photodiode 99 can be, but not limited to Si photodiode, or Ge photodiode.

Electrical connectors 104 may be located on the front side of the U-shaped structure. An electronic PCB module 106 may be located inside the U-shaped structure of the optical sensing unit and configured to control the operation of the optical sensing unit and transmitting corresponding data through the electrical connectors 104 to the control system.

All the elements of the above-described optical sensing unit may be packaged inside an enclosure 115 of the U-shaped structure such that all the components are protected from the environment.

In some embodiments, the optical sensing unit is also configured to perform reference measurements for the purposes of calibration and fault detection of similar sensing units. To this end, a reference beam from the light source 90 is measured by an additional detector (e.g. photodiode).

The optical sensing unit may be configured and operated to perform a reference measurement session using emission of a reference beam from the light source 90 and detection thereof using an additional photodiode.

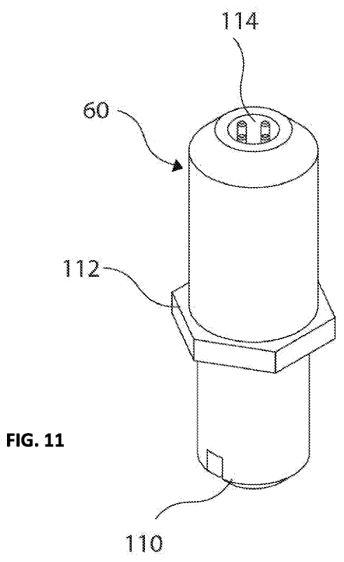

Reference is made to FIG. 11 which illustrates the exemplary electrode sensing unit 60 suitable to be used in monitoring system of the invention. Generally, the electro-chemical sensing unit may be of any known suitable type and configuration. Such sensing unit 60 can be, but not limited to pH sensor, ORP sensor, ion-selective sensors, EC sensor, etc.

The electrode sensing unit 60 can include one or more electrodes 110. The electrode(s) 110 of the electrode sensing unit 60 is/are configured to be immersed in the fluid.

As shown in the figure, the electrode sensing unit 60 may include a fastener 112 mounted for freely movement around a body of the electrode sensing unit 60. A gasket or other appropriate sealing elements (not shown) may be provided below the fastener's rim to provide a moisture-proof barrier to prevent fluids to pass between the fastener and the surface of the mounting bore (66 or 68 in FIG. 7)

An electrical connector 114 may be located on the upper side of the electrode sensing unit 60, to connect the electrode sensing unit 60 to the respective elements in the housing of the system.

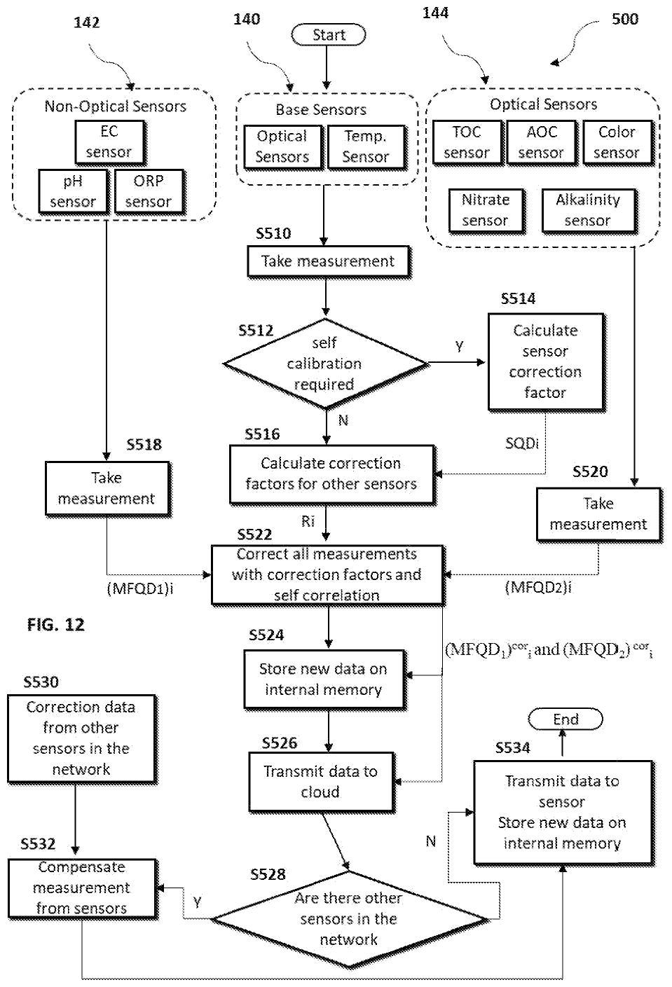

FIG. 12 illustrates a flow diagram 500 of an exemplary process of performing a measurement session by the fluid (e.g. water) quality monitoring system of the invention.

For convenience, in this example, the sensing units that are accommodated inside the water quality monitoring system are divided into three functional groups: a base sensors group 140, non-optical sensors group 142, and optical sensors group 144. The base sensors group 140 includes at least one optical sensing unit (e.g. having U-shaped structure), and possibly also a temperature electrode sensing unit. The base sensors group 140 is configured for monitoring the operational condition of the sensing system and provide data indicative of the sensing quality of the sensing system (SQD in FIGS. 1 and 2).

It should be understood that additional or different sensing units may be used in the base sensors group 140.

The non-optical (electrochemical or electrode-based) sensors group 142 may include EC sensor, pH sensor, ORP sensor, etc. The electrode sensing units of group 142 may include sensors such as, but not limited to, dissolved oxygen, Ion-selective electrode sensors, etc. The non-optical sensors group 142 is configured to provide the non-optical (e.g. electro-chemical) measured data indicative of the fluid quality (MFQD₁ in FIGS. 1 and 2).

Optical sensors group 142 (e.g. utilizing the above described U-shaped optical sensing units) may include a TOC sensor, AOC sensor, N—NO3 sensor, color sensor, and alkalinity sensor. This group 142 is thus configured for sensing fluid quality parameters and provide second optically measured data indicative of the fluid quality (MFQD₂ in FIGS. 1 and 2).

The monitoring system may first take a preliminary reading from the base sensors group 140 (step S510). Such preliminary reading is aimed at verifying whether optical response of the fluid to predetermined illumination and preferably also verifying whether measured optical properties of the sensing unit(s) are within certain acceptable ranges, and based on such verification determining whether a self-calibration routine is required (step S512).

If the preliminary readings are within the acceptable ranges and thus self-calibration routine is not required, the monitoring system proceeds to calculation of correction factors to be used for correction of the measured data obtained by the optical sensing units of group 144 and the measured data obtained by the electrode sensing units of group 142 (step S516). More specifically, in step S516, the control system associated with the monitoring system (e.g. local control system or remote central control system) operates to assign weighting factors to the preliminary readings depending on their location in the respective acceptable ranges and by this evaluate possible effect of the operational condition of the sensing units of base group 140 (and, accordingly, predicted operational condition of the sensing units of groups 142 and 144) on measured data obtained by the sensing units of groups 142 and 144. Thus, if the measurement taken in step S510 shows that the self-calibration of the base group 140 is not required, the system calculates the correction factors for other sensors at step S516 as it was with the previous readings.

If self-calibration routine is required (i.e. the preliminary readings are outside the acceptable ranges), the monitoring system proceeds to calculation of correction factors for data obtained by the sensing unit(s) of the base group 140 (step S514), and then moves to step S516.

In steps S518 and S520 (which may or may not be performed concurrently), the monitoring system operates to perform measurements by all the electrode sensing units of group 142 and all the optical sensing units of group 144 to obtain respective fluid quality measured data (MFQD₁)ᵢ and (MFQD₂)ᵢ.

Then, in step S522, the monitoring system verifies reliability of the predicted relation R, and applies the calculated correction factors determined in step S516 to the measured data, (MFQD₁)ᵢ and (MFQD₂)ᵢ, provided by all the measurements of the electrode sensing units 142 and the optical sensing units 144. In addition, in step S522, the monitoring system may perform a self-correlation between all the acquired measurements.

Then in step S524 the monitoring system stores new data (corrected measured data), (MFQD₁)^{cor}ᵢ and (MFQD₂)^{cor}ᵢ, in the internal memory, and transmits this data to the cloud (to the central control system)—step S526.

Then, in step S528, the central control system determines whether there are other fluid quality monitoring systems in the fluid network. If there is no other system in the fluid network, the central control system reports back to the i-th monitoring system that the acquired measurements are the final measurements. Otherwise, if there are other monitoring systems in the network, the central control system identifies additional correction data based on data received from the other fluid monitoring system(s) to correlate the measurement acquired by the given i-th system in step S530, and then compensates the measurement from the sensing units, further corrects the measured data obtained by the i-th monitoring system (step S532).

Then, in step S534 the data from the central system is transmitted back to the given i-th monitoring system, and new data is stored on the internal memory (and possibly presented on the display panel 74).

The configuration and operation of the optical sensing unit(s) used for determination of the sensing quality data have been described below (and exemplified with reference to FIG. 3), namely the ability of such sensing unit to determine the optical properties of optical elements involved in the measurements, i.e. optical windows (and possibly lens units). Such optical properties include transmission and scattering through and from the optical window(s). Preferably, measurements are taken over time to identify dynamics in the degradation of the optical properties.

It should be noted that division of the optical sensing units into those responsible for the measuring the sensing quality and the fluid quality, i.e. the use of separate optical sensing units for these two purposes may or may not be implemented. Indeed, the same optical sensing unit may be configured to measure one or more parameters of the fluid and perform self-diagnostic of its operational condition.

It should also be noted that one the parameters of the fluid that should preferably be determined at the preliminary stage is the fluid turbidity, which also affects measurements of other fluid quality parameters. As described above with reference to FIG. 3, by accommodating the “scattering detector” at 90 degrees orientation with respect to illumination path, such detector can measure both the fluid turbidity and the scattering from optical window(s).

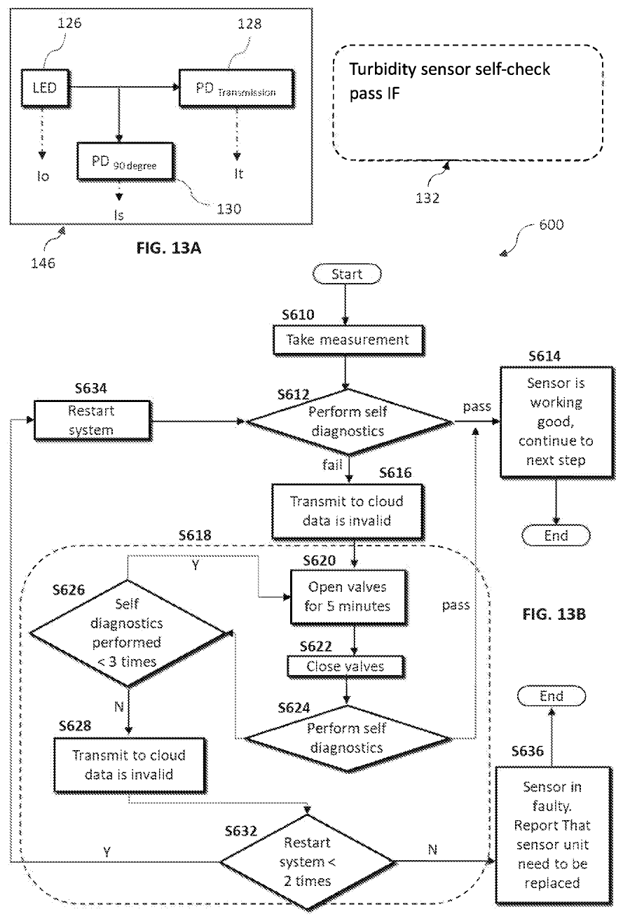

FIGS. 13A and 13B illustrate, respectively, the configuration and operation of such optical sensing unit 146 and a flowchart 600 of the exemplary process for evaluating fault turbidity measurements by the optical sensing unit 146. The optical sensing unit 146 is configured similar to the optical sensing OSUᵢ of FIG. 3, but here in FIG. 13A only the details of the optical scheme relevant mainly for turbidity sensing are shown.

The optical sensing unit 146 includes a light source device (e.g. including LED(s)) 126, and a detection device which includes a “transmission” detector (e.g. photodiode) 128 accommodated to define a detection channel parallel to the illumination channel defined by the light source device and a “scattering detector” (e.g. photodiode) 130 accommodated at a 90-degree orientation of its light sensitive surface with respect to the illumination path. In some embodiments, the light source device 126 is configured to produce 760 nm light and/or 820 nm and/or white light. However, it will be recognized that other wavelengths can be used for the same purpose.

The characteristics (at least intensity I₀) of the light source device 126 (each light emitting element thereof) is measured. The intensity of light response of the fluid that is measured by the transmission photodiode 128 is denoted as Iₜ, and the intensity of light response of the fluid measured by the scattering photodiode 130 denoted as Iₛ.

A turbidity ratio function F(NTU) can be defined by a ratio of transmission and scattering intensities Iₜ and measured Iₛ:

$$F ( NTU ) = \frac{{I}_{t} ( NTU )}{{I}_{s} ( NTU )}$$

The turbidity sensing unit self-check can be classified as “acceptable if the following condition is satisfied:

0.X·F(NTU)<Iₜ/Iₛ<1.Y·F(NTU) for 0.05<X<0.5 and 0.05<Y<0.5

Thus, as shown in FIG. 13B, the system may operate to acquires (at the preliminary self-diagnostic stage) the reading from the turbidity sensing unit 146 (step S610). Then, in step S612 the system performs the above-described self-diagnosis test of the turbidity sensing unit 146. If the test passed, the sensing unit notifies its logic board (e.g. corresponding notification is generated/recorded by the local controller) that the operational state of the sensing unit 146 satisfies the requirements (step S614) and the system proceeds to next steps in the self-diagnostic and measurement procedures.

If the above test fails, then the system operates to transmit corresponding data to the cloud (central control system)—step S616, and the first testing routine stage starts—steps S618.

In some embodiments, the first testing routine procedure is performed k times, where 1<k<5. In some embodiments, the procedure starts from step S620 by opening the control valves for a few minutes (e.g. 5 minutes) such that the fluid to be measured can flow through the fluid sensing system, and then in step S622 the system closes the control valves; in some other embodiments, there are no valves in the sensing system, so the system moves directly to step S624.

In step S624, the system repeats the turbidity self-diagnosis test 132 of the sensing unit 146. If the test passes, the system proceeds to step S614; and if the self-diagnosis test fails, the system verifies whether the self-diagnosis test was performed less than the predetermined k times (step S626). If the self-diagnosis test was performed less then k times, the first testing routine stage S618 starts again from step S620. Otherwise, if the self-diagnosis test was performed more than k times, data indicative of unreliability of the sensing unit 146 is transmitted to the cloud (central control system) in step S628 and a second testing routine stage is initiated.

In some embodiments, the second testing routine stage is performed j times, where 1<j<3. This second testing routine stage starts from step S632 by inquiring how many times the system went through the second testing routine stage. If another routine is required, the system goes to step S634 and restarts the system operation. Then it repeats the operation from step S612. If in step S632 the number is larger than j, a decision is made that the sensing unit is faulty (step S636) and data indicative of that the turbidity sensing unit 146 is faulty is transmitted to the cloud.

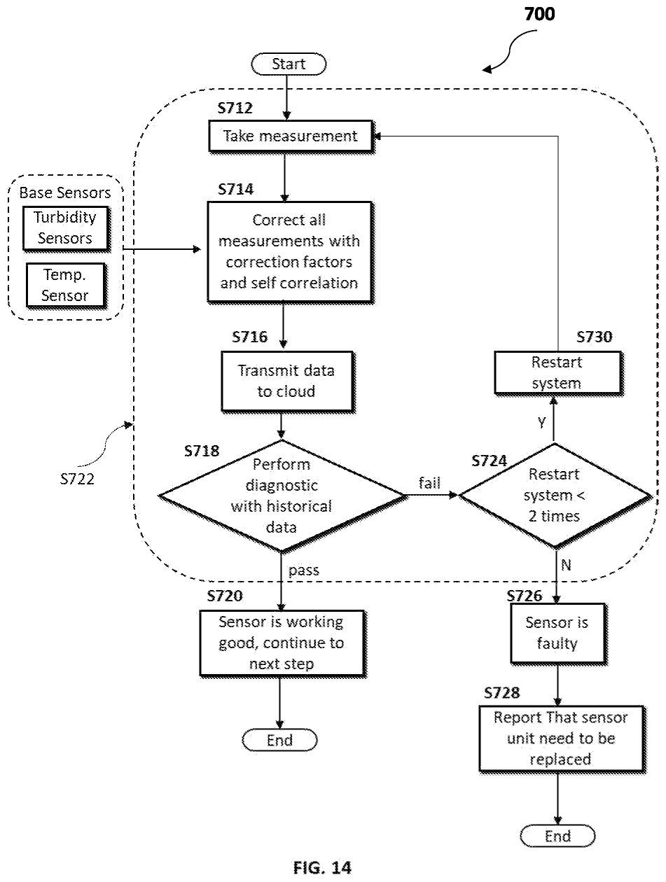

FIG. 14 illustrates a flowchart 700 of the exemplary process for evaluating fault in the operational conditions of the optical sensing units 144 and electrode sensing units 142.

In some embodiments, the system operates to acquire measurements from all the optical sensing units 144 and all the electrode sensing units 142 (step S712). Then in step S714, the system operates to apply correction to all the measurements using correction factors that were calculated from the measurements of base sensing units 140 as described above, and all the data is transmitted to the control system (e.g. to the cloud) for further analysis (step S716).

In step S718, the diagnostics are performed using the correlation between the acquired measurements and the historical data. Then, if the diagnostic tests passed, the decision is made that all the optical sensing units 144 and electrode sensing units 142 are working properly and this is reported to the monitoring system (step S720) which correspondingly continues to next step. If in step S718 it is identified that at least one of the optical sensing units 144 or electrode sensing units 142 does not pass the diagnosis test, the testing routine stage S722 is initiated.

According to some embodiments, the testing routine is performed j times, where 1<j<3.

The testing routine may start from step S724 by checking how many testing routine stages S722 were performed. If more than j, then a decision is made that at least one of the sensing units is faulty (step S726), and corresponding data indicative of that at least one of the sensing units needs to be replaced is generated (step S728).

If in step S724 the amount of testing procedure loops of stage S722 is less than j, the system operation is restarted in step S730 and then the testing routine starts again from step S712.

Thus, the present invention provides an effective technique for fluid quality measurement together with self-diagnostic of the measurement/sensing system. Such technique also facilitates maintenance of the sensing system and allows modularity of the system configuration to be effectively used.

1-38. (canceled)

39. A monitoring system configured for monitoring quality of fluid in a fluid chamber, the monitoring system comprising:
a sensing system which comprises sensing units of different types configured to measure multiple parameters of the fluid and generate corresponding measured fluid quality data and to perform self-diagnostic of an operational condition of the sensing system and generate sensing data indicative of sensing quality, and
a control system comprising a local controller configured to be responsive to data indicative of a relation between the measured fluid quality data and the sensing quality and selectively generate operational data to initiate one or more of the following:
generation of alarm signal indicative of an abnormal condition of the quality of the fluid,
correction of the measured fluid quality data in accordance with the sensing quality; and
replacement of one or more elements of the sensing units.

40. The monitoring system according to claim 1, wherein
said sensing units comprise: at least one electrochemical sensing unit configured to measure one or more substances in the fluid and generate first measured data indicative thereof, and at least one optical sensing unit configured to measure one or more substances in the fluid and generate second measured data, the first and second measured data forming said measured fluid quality data,
said at least one optical sensing unit is configured to measure one or more parameters characterizing quality of optical measurements performed by said at least one optical sensing unit and generate optical sensing data characterizing the sensing quality.

41. The monitoring system according to claim 39, wherein said control system comprises:
a data processor configured to receive and analyze the measured fluid quality data and derive therefrom qualitative and quantitative data indicative of a quality level of the fluid being measured; and
an analyzer configured to receive and analyze the sensing quality data and upon identifying deviation of the operational condition of the sensing system from a predetermined normal condition, determining, based on a degree of said deviation, whether the data indicative of the quality level of the fluid derived from the measured fluid quality data is affected by said deviation, and generate said data indicative of the relation between the measured fluid quality data and the sensing quality defining said operational data.

42. The monitoring system according to claim 41, wherein said control system is configured and operable as a node of a fluid network formed by a plurality of similar monitoring systems connectable via a communication network, said analyzer being configured to apply machine learning to measured and sensing data obtained by one or more of said similar monitoring systems and evaluate an effect of the sensing quality on the quality level of the measured fluid, and determine said data indicative of the relation between the measured fluid quality data and the sensing quality.

43. The monitoring system according to claim 39, comprising a communication utility configured to communicate the measured fluid quality data and the sensing data to a remote central system and receive therefrom and communicate to the local controller said data indicative of the relation between the measured fluid quality data and the sensing quality.

44. The monitoring system according to claim 39, wherein:
said control system comprises a data processor configured to receive and analyze the measured fluid quality data and derive therefrom qualitative and quantitative data indicative of a quality level of the fluid being measured, and communicate said data to the local controller; and
a communication utility is provided being configured to communicate said data indicative of the quality of the fluid and the sensing data to a remote central system, and receive therefrom and communicate to the local controller said data indicative of the relation between the measured fluid quality data and the sensing quality defining said operational data.

45. The monitoring system according to claim 43, wherein said control system is configured and operable as a node of a fluid network formed by a plurality of similar monitoring systems and is connectable to said remote central system via a communication network.

46. The monitoring system according to claim 39, characterized by at least one of the following:
the measured fluid quality data comprises multiple data pieces corresponding to parameters of various substances in the fluid, and a relation between said multiple data pieces defines a quality level of the fluid for a given status of the measured fluid quality data, the operational condition of the sensing system affecting said relation between said multiple data pieces;
said fluid chamber is configured for fluid flow therethrough; and
the sensing units are configured to determine two or more of the following parameters of the fluid: nitrate contents, turbidity, color, iron contents, total organic carbon contents, assimilable organic carbon contents, total dissolves solids contents, hardness, alkalinity, bacteria;
comprises a housing having a modular configuration for carrying multiple individual elements of said sensing system in said modules, thereby enabling replacement of one or more of said elements.

47. The monitoring system according to claim 40, comprising a housing having a modular configuration for carrying multiple individual elements of said sensing system in said modules, thereby enabling replacement of one or more of said elements, wherein said individual modules comprise modules which are configured to carry, respectively, each of said at least one electrochemical sensing unit allowing an active part of the sensing unit to be exposed to the fluid being monitored, and light source and detection devices of said at least one optical sensing unit allowing them to be exposed to the fluid being monitored via optical windows.

48. The monitoring system according to claim 40, wherein said at least one optical sensing unit is characterized by at least one of the following:
said at least one optical sensing unit is associated with optical windows and is configured to illuminate the fluid and detect light returned from the fluid via said optical windows, detected light being thereby indicative of light response of the one or more substances in the fluid and indicative of optical properties of the optical windows characterizing the quality of the optical measurements performed by said at least one optical sensing unit;
said at least one optical sensing unit comprises one or more light emitting diodes (LEDs); and
said at least one optical sensing unit is configured to generate illumination of one or more wavelength ranges including one or more of the following: 230 nm, 234 nm, 255 nm, 275 nm, 420 nm, 530 nm, 632 nm, 760 nm, white light.

49. The monitoring system according to claim 48, wherein said at least one optical sensing unit is associated with optical windows and is configured to illuminate the fluid and detect light returned from the fluid via said optical windows, detected light being thereby indicative of light response of the one or more substances in the fluid and indicative of optical properties of the optical windows characterizing the quality of the optical measurements performed by said at least one optical sensing unit, said at least one optical sensing unit being configured to carry out at least one of the following: provide the detected light indicative of at least one of transmission and scattering properties of each of the optical windows; and provide the detected light indicative of the light response of the fluid comprising one or more of the following properties of the fluid: absorption; transmission in at least one of ultraviolet, visible, near- and mid-infrared spectra, fluorescence, RAMAN.

50. The monitoring system according to claim 48, wherein said at least one optical sensing unit comprises: a light source device comprising one or more light sources configured to generate one or more illuminating wavelength ranges to illuminate the fluid and cause the light response of the fluid; and an optical detector device comprising one or more detectors configured to detect light of one or more wavelengths and generate said second measured data indicative of the one or more substances in the fluid, said optical detector device comprising at least one detector accommodated to detect light components transmitted through the optical windows and light components scattered from at least one of said optical windows.

51. The monitoring system according to claim 47, characterized by at least one of the following:
said optical windows are defined at least by transparent portions of the fluid chamber to which said at least one optical sensing unit is exposed; and
said housing comprises said optical windows.

52. The monitoring system according to claim 47, wherein said housing is configured to define at least one substantially U-shaped structure defining an inner space for receiving at least a part of the fluid chamber having at least one optically transparent portion, said U-shaped structure carrying the light source and the detection devices of the optical sensing unit.

53. The monitoring system according to claim 52, wherein the light source of the optical sensing unit is located on one of the arms of the U-shaped structure, at least one of the detection devices of said optical sensing unit is located on the other opposite arm of the U-shaped structure, and at least one other detection device of said optical sensing is located in a vicinity of an apex region of the U-shaped structure, thereby allowing the light source and the detection devices to be exposed to the fluid in the chamber and perform optical measurements of the parameters of the fluid and the self-diagnostic of the operational condition of the sensing system.

54. The monitoring system according to claim 52, wherein said U-shaped structure defined by the housing comprises optical windows, such that when at least a part of the housing including said U-shaped structure is located inside the fluid chamber, the light source and the detection devices of the optical sensing unit are exposed to the fluid via said optical windows and perform optical measurements of the parameters of the fluid and the self-diagnostic of the operational condition of the sensing system.

55. The monitoring system according to claim 47, wherein the housing is configured to enable monitoring of the fluid passing through a portion of the housing, the housing comprising: a body having an inlet and an outlet defining a fluid path therebetween for establishing fluid communication with a fluid line; at least one examination tube configured to be disposed within said body along said fluid path and having at least one at least partially transparent portion for allowing optical measurement of the fluid passing within said examination tube by said at least one optical sensing unit; and at least one examination chamber disposed within the body along said fluid path and carrying the at least one electrochemical sensing unit allowing electrical measurement of the fluid passing within the examination chamber.

56. The monitoring system according to claim 39, wherein the control system is configured to automatically identify the types of the sensing units of the sensing system.

57. The monitoring system according to claim 40, wherein the control system is configured to utilize data indicative of the types of the sensing units of the sensing system, and determine, based on the optical sensing data and the relation between the optical sensing data and the measured quality data, correlation between a change in the sensing quality of said at least one optical sensing unit and an operational condition of the at least one electro-electrochemical sensing unit, to update the operational data.

58. A control system for use in monitoring quality of a fluid, the control system being connected to a communication network configured for data communication with at least one monitoring system including a sensing system comprising sensing units of different types configured to measure multiple parameters of the fluid and generate corresponding measured fluid quality data and to perform self-diagnostic of an operational condition of the sensing system and generate sensing data indicative of sensing quality, said control system being configured as a computer system comprising
a data processor and analyzer being configured to be responsive to input data from the monitoring system comprising measured fluid quality data and sensing data, to carry out the following: analyze the measured fluid quality data and derive therefrom qualitative and quantitative data indicative of a quality level of the fluid being measured; and analyze the sensing data, and upon identifying deviation of an operational condition of the sensing system from a predetermined normal condition, determining, based on a degree of said deviation, whether the quality level derived from the measured fluid quality data is affected by said deviation, and determine data indicative of a relation between the measured fluid quality data and sensing quality of said sensing system; and generate corresponding output data to be communicated to a local controller of said monitoring system, said output data being indicative of operational data for said sensing system aimed at initiating one or more of the following: generation of alarm signal indicative of an abnormal condition of the quality of the fluid being monitored, correction of the measured fluid quality data in accordance with the sensing quality; and replacement of one or more elements of the sensing units of said sensing system.

59. The control system according to claim 58, configured as a central control system connected to a communication network for data communication with more than one of the monitoring systems, the control system further comprising a data input utility configured to be responsive to request data from each monitoring system and configured to identify the monitoring system that has initiated said request data via an identification code assigned to said monitoring system.

60. A method for monitoring quality of a fluid, the method comprising:
providing data indicative of measurements obtained in one or more sensing sessions performed on the fluid by at least one electro-optical sensing unit and at least one optical sensing unit, said data indicative of the measurements comprising measured fluid quality data indicative of multiple parameters of the fluid and data indicative of operational condition of at least said at least one optical sensing unit corresponding to sensing quality in said one or more sensing sessions;
determining a relation between the measured fluid quality data and the sensing quality; and
based on said relation, selectively generating operational data to initiate one or more of the following: generation of alarm signal indicative of an abnormal condition of the quality of the fluid, correction of the measured fluid quality data in accordance with the sensing quality; and replacement of one or more elements of the sensing units.

61. The method according to claim 60, wherein said relation between the measured fluid quality data and the sensing quality is indicative of a change in the measured fluid quality data associated with a change in the sensing quality data, said relation being determined based on history of measurements performed by given at least one electro-optical sensing unit and given at least one optical sensing unit on a given fluid type, and a predetermined expected dynamics in measurements taken over time by said given sensing units.

62. A monitoring system configured for monitoring quality of fluid, the monitoring system comprising:
a sensing system which is configured and operable to measure fluid quality data and to perform self-diagnostic of an operational condition of the sensing system, the sensing system comprising: at least one electrochemical sensing unit configured to measure one or more substances in the fluid and generate first measured data characterizing measured fluid quality data, and at least one optical sensing unit configured to measure one or more parameters characterizing quality of optical measurements performed by said at least one optical sensing unit and generate optical sensing data characterizing sensing quality of the sensing system; and
a control system configured and operable to selectively generate operational data to initiate one or more of the following operational conditions: generation of alarm signal indicative of an abnormal condition of the quality of the fluid, correction of the measured fluid quality data in accordance with the sensing quality; and replacement of one or more elements of the sensing units; wherein the operational data is defined by a relation between the measured fluid quality data and the sensing quality, said relation being indicative of a change in the measured fluid quality data associated with a change in the sensing quality data and being determined based on history of measurements performed by a given sensing system on a given fluid type, and a predetermined expected dynamics in measurements taken over time by said given sensing system.

63. The monitoring system according to claim 62, wherein said control system comprises: a data processor configured to receive and analyze the measured fluid quality data and derive therefrom qualitative and quantitative data indicative of a quality level of the fluid being measured; and an analyzer configured to receive and analyze the sensing quality data and upon identifying deviation of an operational condition of the sensing system from a predetermined normal condition, determining, based on a degree of said deviation, whether the data indicative of the quality level of the fluid derived from the measured fluid quality data is affected by said deviation, and generate said data indicative of the relation between the measured fluid quality data and the sensing quality defining said operational data.

64. The monitoring system according to claim 63, wherein said control system is configured and operable as a node of a fluid network formed by a plurality of similar monitoring systems connectable via a communication network, said analyzer being configured to apply machine learning to measured and sensing data obtained by one or more of said similar monitoring systems and evaluate an effect of the sensing quality on the quality level of the measured fluid, and determine said data indicative of the relation between the measured fluid quality data and the sensing quality.

65. The monitoring system according to claim 62, comprising a communication utility configured to communicate the measured fluid quality data and the sensing data to a remote central system and receive therefrom and communicate to the local controller said data indicative of the relation between the measured fluid quality data and the sensing quality.

66. The monitoring system according to claim 62, wherein:
said control system comprises a data processor configured to receive and analyze the measured fluid quality data and derive therefrom qualitative and quantitative data indicative of a quality level of the fluid being measured, and communicate said data to the local controller; and
a communication utility is provided being configured to communicate said data indicative of the quality of the fluid and the sensing data to a remote central system and receive therefrom and communicate to the local controller said data indicative of the relation between the measured fluid quality data and the sensing quality defining said operational data.

67. The monitoring system according to claim 65, wherein said control system is configured and operable as a node of a fluid network formed by a plurality of similar monitoring systems and is connectable to said remote central system via a communication network.
